(19) United States
(12) Patent Application Publication
(10) Pub. No.: US 2024/0284058 A1
(43) Pub. Date: Aug. 22, 2024

(54) INFORMATION PROCESSING DEVICE AND METHOD

(71) Applicant: Sony Semiconductor Solutions Corporation, Kanagawa (JP)

(72) Inventors: Atsushi Tsuboi, Kanagawa (JP); Hidetomo Hirao, Kanagawa (JP)

(21) Appl. No.: 18/567,568

(22) PCT Filed: Feb. 24, 2022
(86) PCT No.: PCT/JP2022/007466

§ 371 Date: Dec. 6, 2023

(30) Foreign Application Priority Data
Jul. 12, 2021 (JP) 2021-115103

(51) Int. Cl. H04N 23/81; H04N 19/65; H04N 19/70

(52) U.S. Cl. CPC H04N 23/81; H04N 19/65; H04N 19/70

(57) ABSTRACT

The present disclosure relates to an information processing device and method that can suppress a loss of subjective image quality when the loss is caused by error concealing.

Reconstruction information is generated, and the generated reconstruction information is transmitted. The reconstruction information corresponds to a reconstructed image obtained by reconstructing a RAW image by using a predetermined parameter and identifies the value of the parameter, the RAW image being outputted from a sensor for detecting incident light in each pixel of a pixel array. The reconstruction information is received, and a transmission error of the reconstructed image is concealed on the basis of the received reconstruction information. The present disclosure can be applied to, for example, an information processing device, an encoding device, a decoding device, an electronic device, an information processing method, or a program.

### TECHNICAL FIELD

The present disclosure relates to an information processing device and method, and particularly to an information processing device and method that can suppress a loss of subjective image quality.

### BACKGROUND ART

Conventionally, a camera system transmits a RAW image, which is outputted from an imaging element, to a monitor device from a camera device, generates a captured image by development or image processing on the RAW image on the monitor device, and displays the image. Such recent imaging elements used for camera systems have a higher density, a higher frame rate, and a higher dynamic range in response to improvements of semiconductor manufacturing technology and element configuration technology, so that RAW images outputted from imaging elements have a larger data amount.

Thus, a method for transmitting an encoded (compressed) RAW image to an image processing LSI has been examined. In encoding of a RAW image, a reduction in encoding efficiency can be further reduced by applying an encoding method using a prediction with a correlation in an image (between pixels) or a correlation between images, for example, JPEG (Joint Photographic Experts Group), MPEG (Moving Picture Experts Group), AVC (Advanced Video Coding), HEVC (High Efficiency Video Coding), or VVC (Versatile Video Coding).

However, in the case of a RAW image, correlativity between nearby pixels is low and thus such a method may reduce encoding efficiency. Hence, a method for dividing a RAW image into images for R, G, and B of a color filter and encoding the images for the respective colors has been examined (for example, see PTL 1). This has improved prediction accuracy in an image (between pixels) and further suppressed a reduction in encoding efficiency.

Moreover, in the event of a transmission error in the transmission of image data, error concealing has been used to conceal an error by using received image data.

### CITATION LIST

### Patent Literature

### [PTL 1]

JP 2003-125209A

### SUMMARY

### Technical Problem

However, if a RAW image is transmitted after being divided into images for respective colors as described in PTL 1, error concealing in a conventional method is performed using an image that is received immediately before and has a different color from an image having a transmission error. Thus, the subjective image quality of a decoded image may be reduced.

The present disclosure has been devised in view of such circumstances and is configured to suppress a loss of subjective image quality that may be reduced by error concealing.

### Solution to Problem

An information processing device according to an aspect of the present technique is an information processing device including: a reconstruction information generating unit that generates reconstruction information that corresponds to a reconstructed image obtained by reconstructing a RAW image by using a predetermined parameter and identifies the value of the parameter, the RAW image being outputted from a sensor for detecting incident light in each pixel of a pixel array; and a transmitting unit that transmits the reconstruction information.

An information processing method according to an aspect of the present technique is an information processing method including: generating reconstruction information that corresponds to a reconstructed image obtained by reconstructing a RAW image by using a predetermined parameter and identifies the value of the parameter, the RAW image being outputted from a sensor for detecting incident light in each pixel of a pixel array; and transmitting the generated reconstruction information.

An information processing device according to another aspect of the present technique is an information processing device including: a receiving unit configured to receive reconstruction information that corresponds to a reconstructed image obtained by reconstructing a RAW image by using a predetermined parameter and identifies the value of the parameter, the RAW image being outputted from a sensor for detecting incident light in each pixel of a pixel array; and a concealing unit that conceals a transmission error of the reconstructed image on the basis of the reconstruction information.

An information processing method according to another aspect of the present technique is an information processing method including: receiving reconstruction information that corresponds to a reconstructed image obtained by reconstructing a RAW image by using a predetermined parameter and identifies the value of the parameter, the RAW image being outputted from a sensor for detecting incident light in each pixel of a pixel array; and concealing a transmission error of the reconstructed image on the basis of the received reconstruction information.

In an information processing device and method according to an aspect of the present technique, reconstruction information is generated and the generated reconstruction information is transmitted. The reconstruction information corresponds to a reconstructed image obtained by reconstructing a RAW image by using a predetermined parameter and identifies the value of the parameter, the RAW image being outputted from a sensor for detecting incident light in each pixel of a pixel array.

In an information processing device and method according to another aspect of the present technique, the reconstruction information is received and a transmission error of the reconstructed image is concealed on the basis of the received reconstruction information. The reconstruction information corresponds to the reconstructed image obtained by reconstructing a RAW image by using a predetermined parameter and identifies the value of the parameter, the RAW image being outputted from a sensor for detecting incident light in each pixel of a pixel array.

### BRIEF DESCRIPTION OF DRAWINGS

FIG. 1 shows an example of transmission of a captured image.

FIG. 2 shows an example of transmission of a RAW image.

FIG. 3 is an explanatory drawing of an example of error concealing.

FIG. 4 is an explanatory drawing of a method for generation and transmission of reconstruction information.

FIG. 5 is an explanatory drawing of an example of error concealing.

FIG. 6 shows an example of a RAW image of a color image sensor.

FIG. 7 shows an example of reconstructed images.

FIG. 8 shows an example of a RAW image of a monochrome polarizing sensor.

FIG. 9 shows an example of reconstructed images.

FIG. 10 shows an example of a RAW image of a color polarizing sensor.

FIG. 11 shows an example of reconstructed images.

FIG. 12 shows an example of reconstructed images.

FIG. 13 shows an example of a RAW image of a multispectral image sensor.

FIG. 14 shows an example of reconstructed images.

FIG. 15 shows an example of reconstructed images.

FIG. 16 shows an example of error concealing.

FIG. 17 shows an example of error concealing.

FIG. 18 is an explanatory drawing of the reception of reconstruction information and an error concealing method.

FIG. 19 is an explanatory drawing of the reception of reconstruction information and an error concealing method.

FIG. 20 is a block diagram showing a main configuration example of a sensor data transmit/receive system.

FIG. 21 is a block diagram showing another configuration example of the sensor data transmit/receive system.

FIG. 22 is a flowchart for explaining an example of a transmitting method.

FIG. 23 is a flowchart for explaining an example of a receiving method.

FIG. 24 is a block diagram showing a main configuration example of a computer.

### DESCRIPTION OF EMBODIMENTS

Hereinafter, modes for carrying out the present disclosure (hereinafter referred as embodiments) will be described. The descriptions will be given in the following order.
1. Transmission of RAW image and error concealing
2. Error concealing of reconstructed image
3. First embodiment (sensor data transmit/receive system)
4. Supplement

### 1. Transmission of RAW Image and Error Concealing

<Documents that Support Technical Contents and Terms>

The scope disclosed in the present technique is not limited to the contents described in the embodiments and also includes the contents described in the following NPLs and the like that were known at the time of filing, the contents of other literatures referred to in the following NPLs.

### [PTL 1]

### (Aforementioned)

### [NPL 1]

TELECOMMUNICATION STANDARDIZATION SECTOR OF ITU, “Versatile video coding”, SERIES H: AUDIOVISUAL AND MULTIMEDIA SYSTEMS Infrastructure of audiovisual services—Coding of moving video, Recommendation ITU-T H.266, August 2020

### [NPL 2]

Recommendation ITU-T H.264 (April 2017) “Advanced video coding for generic audiovisual services”, April 2017

### [NPL 3]

Recommendation ITU-T H.265 (February 2018) “High efficiency video coding”, February 2018

In other words, the contents in the NPLs and the contents of other literatures referred to in the foregoing NPLs are also grounds for determining support requirements.

### <Sensor Data Transmit/Receive System>

A conventional system is configured such that a RAW image outputted from an imaging element is subjected to development or image processing in a camera device to generate a captured image, the captured image is transmitted from the camera device to a monitor device, and the captured image is displayed on the monitor device.

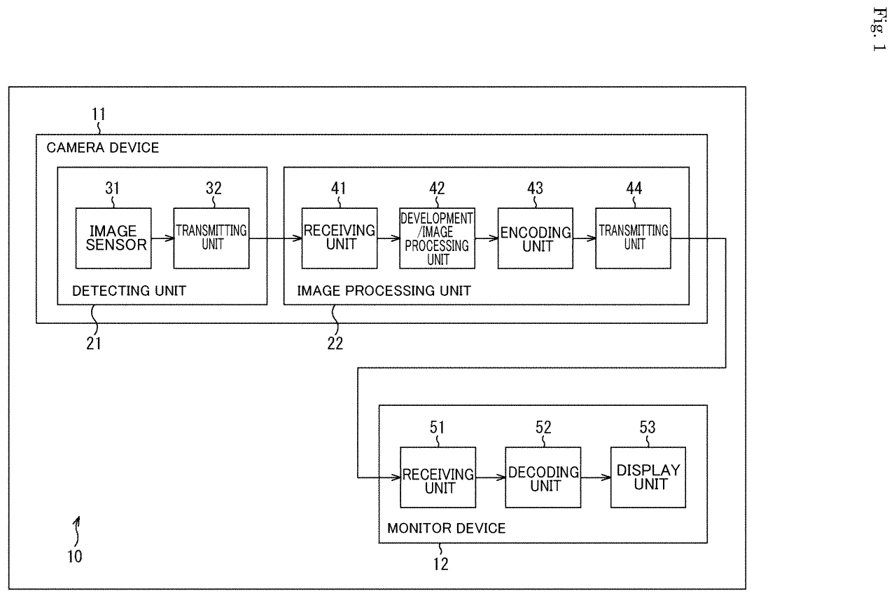

For example, in the case of a sensor data transmit/receive system 10 of FIG. 1, in a camera device 11, an image sensor 31 of a detecting unit 21 detects incident light to generate a RAW image including pixel values for respective components (respective colors). A transmitting unit 32 transmits the RAW image to an image processing unit 22. A receiving unit 41 of the image processing unit 22 receives the RAW image. A development/image processing unit 42 performs development or image processing on the received RAW image and generates a captured image as data for display. An encoding unit 43 encodes the captured image to generate encoded data. A transmitting unit 44 transmits the encoded data of the captured image to a monitor device 12. In the monitor device 12, a receiving unit 51 receives the encoded data. A decoding unit 52 decodes the received encoded data and generates (reconstitutes) the captured image. A display unit 53 displays the captured image.

Another camera system transmits a RAW image, which is outputted from an imaging element, to a monitor device from a camera device, generates a captured image by development or image processing on the RAW image on the monitor device, and displays the image.

The recent imaging elements used for camera systems have a higher density, a higher frame rate, and a higher dynamic range in response to improvements of semiconductor manufacturing technology and element configuration technology, so that RAW images outputted from imaging elements have a larger data amount.

Thus, a method for encoding (compressing) a RAW image and transmitting the RAW image to an image processing LSI was examined.

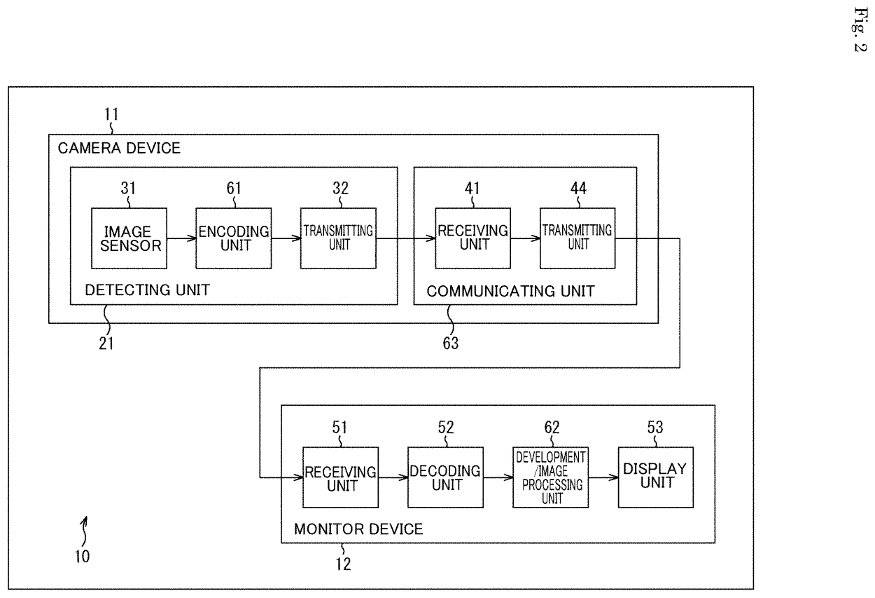

For example, in the case of the sensor data transmit/receive system 10 of FIG. 2, in the camera device 11, the image sensor 31 of the detecting unit 21 detects incident light to generate a RAW image including pixel values for respective components (respective colors). An encoding unit 61 encodes the RAW image and generates encoded data. The transmitting unit 32 transmits the encoded data of the RAW image to a communicating unit 63. The receiving unit 41 of the communicating unit 63 receives the encoded data of the RAW image. The transmitting unit 44 transmits the encoded data of the RAW image to the monitor device 12. In the monitor device 12, the receiving unit 51 receives the encoded data. The decoding unit 52 decodes the received encoded data and generates (reconstitutes) the RAW image. A development/image processing unit 62 performs development or image processing on the RAW image and generates a captured image as data for display. The display unit 53 displays the captured image.

The encoding of the RAW image during transmission can suppress a transmission data rate between devices, thereby reducing problems caused by high-capacity high-speed data transmission between devices. In encoding of the RAW image, a reduction in encoding efficiency can be further reduced by applying an encoding method using a prediction with a correlation in an image (between pixels) or a correlation between images, for example, JPEG (Joint Photographic Experts Group), MPEG (Moving Picture Experts Group), AVC (Advanced Video Coding), HEVC (High Efficiency Video Coding), or VVC (Versatile Video Coding).

However, in the case of a RAW image, correlativity between nearby pixels is low and thus such a method may reduce encoding efficiency.

For example, in the case of a color image sensor, a color filter is provided for a pixel array, and a pixel value in a wave range of red (R), a pixel value in a wave range of green (G), and a pixel value in a wave range of blue (B) are obtained. The color filter allows the passage of incident light of each pixel in the pixel array and limits the wave range of the incident light. The wave range is set for each pixel. Specifically, the color filter includes a filter of one pixel for the passage of the wave range of red (R), a filter of one pixel for the passage of the wave range of green (G), and a filter of one pixel for the passage of the wave range of blue (B). An array of the filters is placed in a predetermined pattern.

Thus, for example, in a pixel provided with the filter for the passage of the wave range of red (R), incident light in the wave range of red (R) is detected and the pixel value of the wave range of red (R) is obtained. In a pixel provided with the filter for the passage of the wave range of green (G), incident light in the wave range of green (G) is detected and the pixel value of the wave range of green (G) is obtained. Moreover, in a pixel provided with the filter for the passage of the wave range of blue (B), incident light in the wave range of blue (B) is detected and the pixel value of the wave range of blue (B) is obtained.

For example, if the filters of the wave ranges are placed in a Bayer layout pattern, a RAW image outputted from the color image sensor includes the pixel values of the wave ranges distributed in a pattern corresponding to a Bayer layout. For example, in the case of a Bayer layout, a RAW image includes rows where the pixel value of the wave range of red (R) and the pixel value of the wave range of green (Gr) are alternately placed and rows where the pixel value of the wave range of green (Gb) and the pixel value of the wave range of blue (B) are alternately placed. In other words, the pixel values of the wave ranges of the same color are not adjacent to each other. The filters of the wave ranges may be placed in any layout pattern, which is not limited to the Bayer layout. Typically, the pixel values of the wave ranges of the same color are unlikely to be adjacent to each other.

Thus, the RAW image obtained by sequential reading from imaging elements includes adjacent pixel values hardly correlated with each other and has a high spatial frequency. Hence, in the case of the foregoing encoding method using a prediction with a correlation in an image (between pixels), the prediction accuracy may be reduced and the encoding efficiency may be impaired.

Therefore, as in the method described in PTL 1, a method was examined such that the pixel values of a RAW image are classified for the respective wave ranges of red (R), green (G), and blue (B) of the color filter, an image (also referred to as a reconstructed image) including the pixel value of one wave range is generated, and the reconstructed image of each wave range is encoded. This improved prediction accuracy in an image (between pixels) and further suppressed a reduction in encoding efficiency.

In the event of a transmission error in the transmission of image data, error concealing is used to conceal an error by interpolating missing data by using received image data.

However, if a RAW image is transmitted after being divided into images for respective wave ranges (colors) as described in PTL 1, error concealing in a conventional method is performed using an image that is received immediately before and has a different wave range (color) from a reconstructed image having a transmission error. Thus, a reconstructed image may be generated (reconstituted) with improper wave ranges of some or all of the pixel values. Furthermore, when a captured image (decoded image) is generated using such a reconstructed image including pixel values in improper wave ranges (colors), the subjective image quality of the decoded image may be degraded.

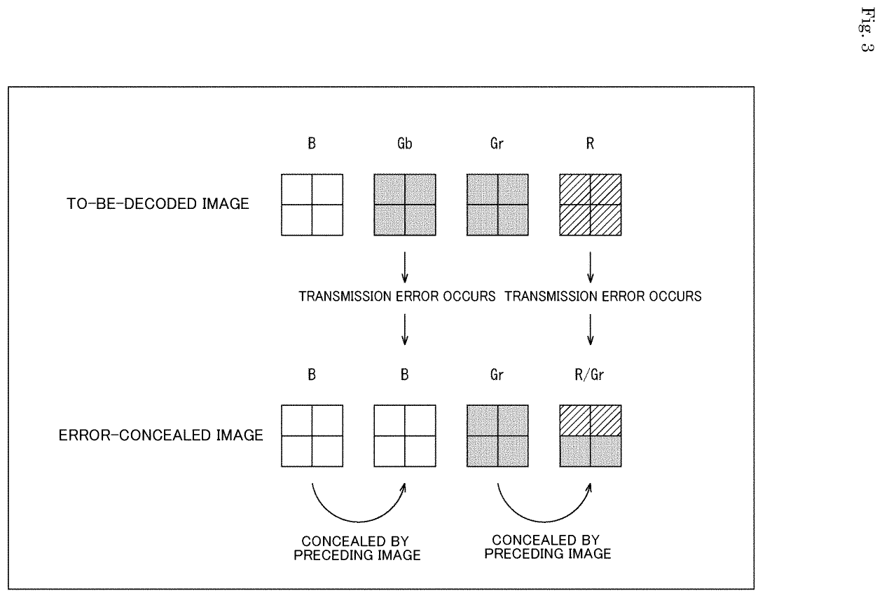

For example, as shown in FIG. 3, it is assumed that the reconstructed image of blue (B), the reconstructed image of green (Gb), the reconstructed image of green (Gr), and the reconstructed image of red (R) are obtained in a receiving device in the absence of a transmission error. However, if a transmission error occurs and, for example, the reconstructed image of green (Gb) is not obtained, the receiving device performs error concealing using the reconstructed image of blue (B), which is received immediately before, and interpolates a lost image. Thus, the reconstructed image of blue (B) is obtained instead of the reconstructed image of green (Gb) to be obtained. Therefore, a decoded image (captured image) is generated using the reconstructed image of blue (B) instead of the reconstructed image of green (Gb) to be used, and thus the subjective image quality of the decoded image may be degraded.

In FIG. 3, if a transmission error occurs and, for example, the reconstructed image of red (R) is partially lost, the receiving device performs error concealing using the reconstructed image of green (Gr), which is received immediately before, and interpolates a lost image. Thus, the pixel value of green (Gr) is mixed in the reconstructed image of red (R). Therefore, a decoded image (captured image) is generated using the pixel value of green (Gr) instead of the pixel value of red (R) to be used, and thus the subjective image quality of the decoded image may be degraded.

### 2. Error Concealing of Reconstructed Image

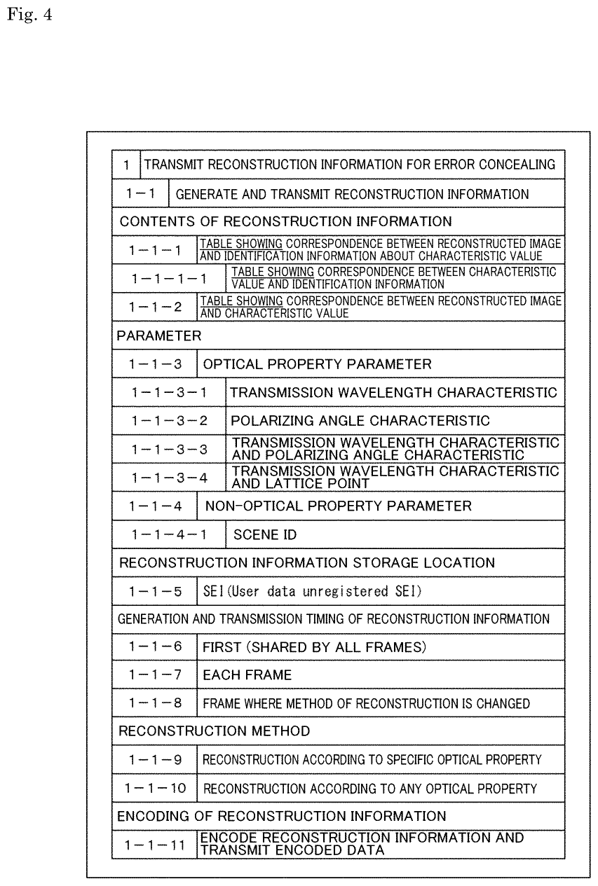

Hence, as shown in the uppermost row of a table in FIG. 4, reconstruction information for error concealing is transmitted (method 1). The reconstruction information corresponds to a reconstructed image obtained by reconstructing a RAW image by using a predetermined parameter and identifies the value of the parameter applied to the reconstruction. For example, if a RAW image detected in a color image sensor is reconstructed by a wave range (color) as described above, the reconstruction information indicates the pixel value of the wave range (color) that constitutes a reconstructed image corresponding to the information. Such reconstruction information is transmitted, and error concealing is performed using the information.

This can suppress the generation of a reconstructed image including a pixel value of an improper wave range (color) through error concealing. Thus, a loss of the subjective image quality of a decoded image (captured image) can be suppressed.

In the present specification, “reconstruction” means extracting the pixel values of pixels having the same value for a predetermined parameter from one or more pixels and organizing the pixel values. To “organize” the pixel values means placing the pixel values in a two-dimensional plane (that is, imaging).

Moreover, in the present specification, “image” means two-dimensional array (distribution) data (also referred to as 2D data) of pixel values obtained in the pixel array of a sensor. In other words, an image may not be data obtained by detecting visible light. For example, an image may be data obtained by detecting black light or a depth value or the like.

### <2-1. Generation and Transmission of Reconstruction Information>

As shown in the second row of a table in FIG. 4, a reconstruction information generating unit of a transmitting device for transmitting a RAW image generates reconstruction information. The reconstruction information corresponds to a reconstructed image obtained by reconstructing a RAW image by using a predetermined parameter and identifies the value of the parameter applied to the reconstruction. The transmitting unit of the transmitting device transmits the reconstruction information (method 1-1).

For example, in an information processing method, reconstruction information may be generated and the generated reconstruction information may be transmitted. The reconstruction information corresponds to a reconstructed image obtained by reconstructing a RAW image by using a predetermined parameter and identifies the value of the parameter, the RAW image being outputted from a sensor for detecting incident light in each pixel of the pixel array.

For example, an information processing device may include a reconstruction information generating unit that generates reconstruction information and a transmitting unit that transmits the reconstruction information, the reconstruction information corresponding to a reconstructed image obtained by reconstructing a RAW image by using a predetermined parameter and identifying the value of the parameter, the RAW image being outputted from the sensor for detecting incident light in each pixel of the pixel array.

With this configuration, the receiving device can identify the component of the received reconstructed image (the value of the parameter used for reconstruction) on the basis of the reconstruction information. In other words, in the event of a transmission error, the receiving device can identify the component of data lost by the transmission error, on the basis of the reconstruction information.

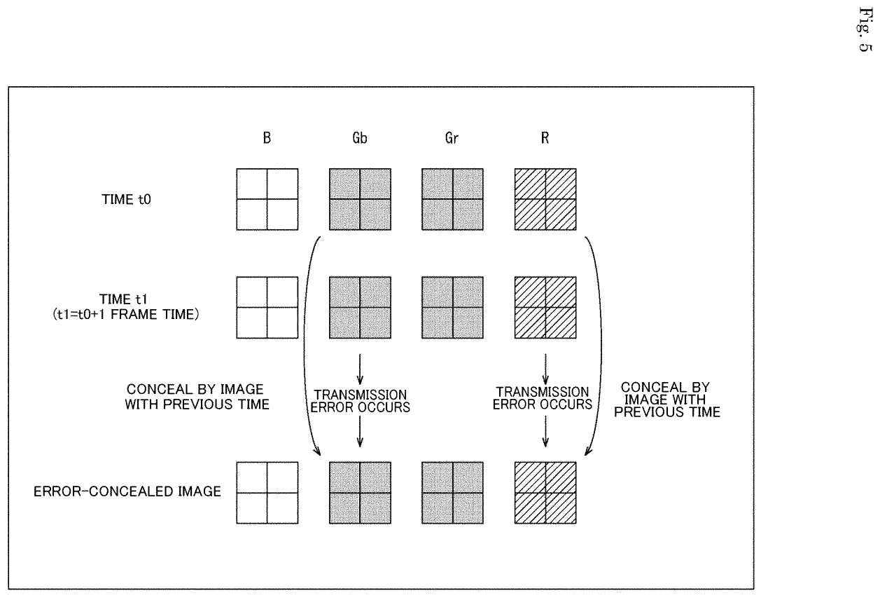

Thus, the receiving device performs error concealing on the basis of the reconstruction information, so that as shown in FIG. 5, error concealing can be performed by using a reconstructed image with the same component (parameter value) as lost data in a received frame (a frame preceding a frame to be processed).

For example, as shown in FIG. 5, it is assumed that the reconstructed image of blue (B), the reconstructed image of green (Gb), the reconstructed image of green (Gr), and the reconstructed image of red (R) are obtained in the receiving device in the absence of a transmission error. If a transmission error occurs and, for example, the reconstructed image of green (Gb) is not obtained, the receiving device performs error concealing using the reconstructed image of green (Gr) of the frame preceding the frame to be processed, thereby interpolating a lost image.

In FIG. 5, if a transmission error occurs and, for example, the reconstructed image of red (R) is not partially obtained, the receiving device performs error concealing using the reconstructed image of red (R) of the frame preceding the frame to be processed, thereby interpolating a lost image.

As described above, the receiving device can suppress the generation of a reconstructed image including a pixel value of an improper wave range (color) through error concealing. Thus, a loss of the subjective image quality of a decoded image (captured image) can be suppressed.

### <Contents of Reconstruction Information>

The reconstruction information will be described below. The reconstruction information may contain any contents. For example, as shown in the fourth row of the table in FIG. 4, the reconstruction information may include information about a correlation between a reconstructed image and identification information about a parameter value (method 1-1-1).

The receiving device only needs to specify, on the basis of the reconstruction information, a reconstructed image to be applied to error concealing on a reconstructed image lost by a transmission error. In other words, in the frame preceding the frame to be processed, the receiving device only needs to specify, on the basis of the reconstruction information, a reconstructed image having the same parameter value for reconstruction as a reconstructed image lost by a transmission error.

Thus, in the reconstruction information, only a correlation between a reconstructed image and a parameter value needs to be indicated. Generally, an information amount of identification information can be smaller than a parameter value. Thus, an increase in the information amount of the reconstruction information can be suppressed by using the identification information instead of a parameter value.

The identification information about a parameter value may be information known to the transmitting device and the receiving device. In this case, it is not necessary to transmit information about the correspondence between each piece of the identification information and a parameter value. Thus, an increase in the information amount of the reconstruction information can be suppressed.

As shown in the fifth row of the table in FIG. 4, the reconstruction information may further include information about a correlation between a parameter value and identification information (method 1-1-1-1). In this case, the receiving device can identify, on the basis of the information, a parameter value indicated by identification information included in information about a correlation between a reconstructed image and a parameter value. In other words, in this case, the receiving device specifies a reconstructed image to be applied to error concealing, on the basis of information about a correlation between a reconstructed image and a parameter value and information about a correlation between a parameter value and identification information, the information being included in the reconstruction information. In other words, identification information unknown to the receiving device can be used.

As shown in the sixth row of the table in FIG. 4, the reconstruction information may include information about a correlation between a reconstructed image and a parameter value (method 1-1-2).

### <Parameter>

Any sensor may be used for generating a RAW image, and any parameter may be used for reconstruction. For example, as shown in the eighth row of the table in FIG. 4, the parameter may include an optical property parameter for an optical property of incident light detected by the sensor (method 1-1-3).

For example, as shown in the ninth row of the table in FIG. 4, the optical property parameter may include a parameter for a transmission wavelength characteristic that is a wavelength characteristic of incident light (method 1-1-3-1).

The transmission wavelength characteristic is a wavelength characteristic of incident light detected in a pixel of the sensor. For example, the transmission wavelength characteristic indicates a color (wave range) (e.g., red (R), green (G), blue (B)) of the color filter that allows the passage of incident light in the color image sensor.

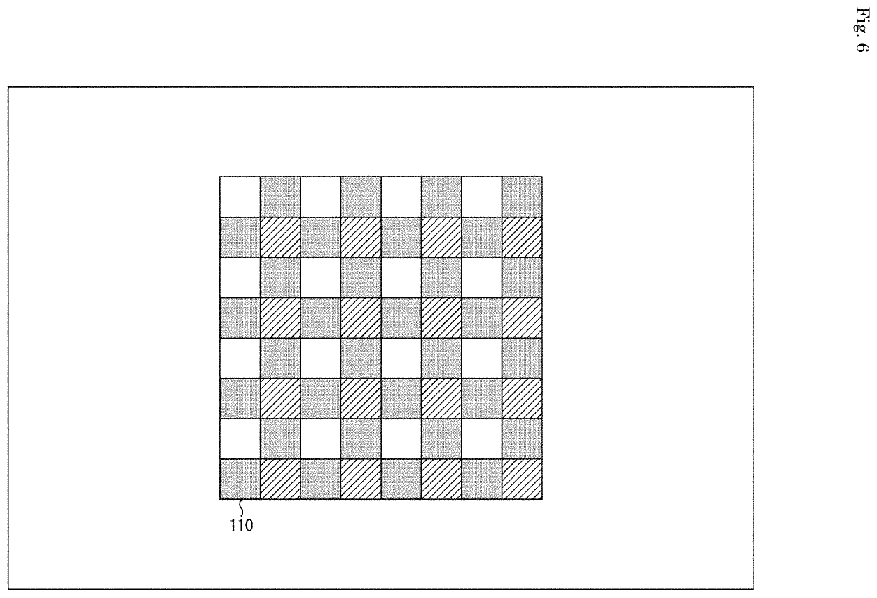

FIG. 6 shows an example of a RAW image outputted from the color image sensor. A RAW image 110 shown in FIG. 6 indicates an example of a RAW image outputted from the color image sensor including color filters of RGB in a pixel array. Each square of the RAW image 110 indicates a pixel value. A white pixel indicates the pixel value of the wave range of blue (B), a gray pixel indicates the pixel value of the wave range of green (G), and a pixel in a hatch pattern indicates the pixel value of the wave range of red (R).

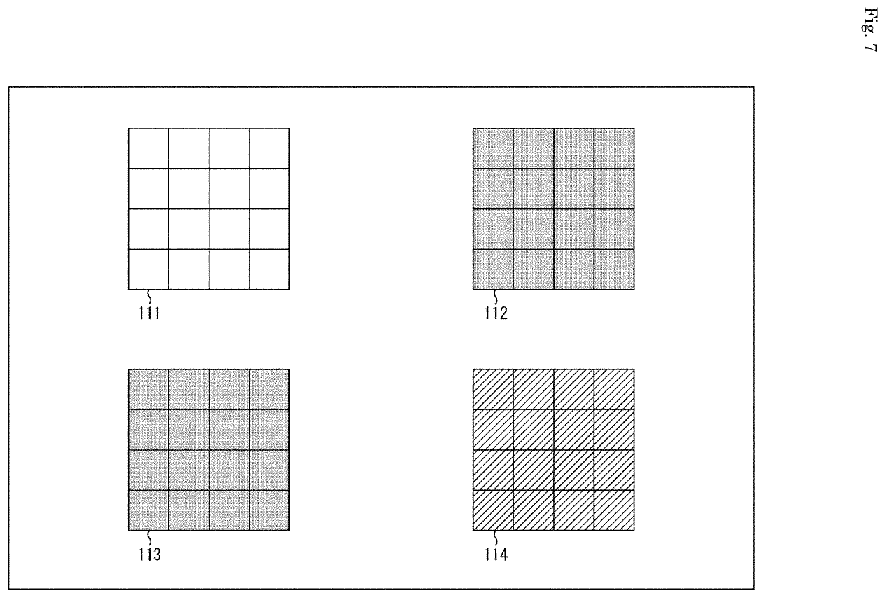

The RAW image 110 is reconstructed by a transmission wavelength characteristic (RGB), so that reconstructed images are obtained as shown in, for example, FIG. 7. In FIG. 7, a reconstructed image 111 is a reconstructed image including the pixel values of the wave range of blue (B). A reconstructed image 112 is a reconstructed image including the pixel values of the wave range of green (Gb). Furthermore, a reconstructed image 113 is a reconstructed image including the pixel values of the wave range of green (Gr). Moreover, a reconstructed image 114 is a reconstructed image including the pixel values of the wave range of red (R).

Such a reconstructed image (encoded data thereof) is transmitted and the reconstruction information is transmitted, so that in the event of a transmission error, the receiving device can perform, on the basis of the reconstruction information, error concealing by using a reconstructed image having the same transmission wavelength characteristic as data lost by the transmission error (a reconstructed image having the same characteristic value of a transmission wavelength characteristic as data lost by the transmission error). Thus, a loss of the subject image quality of a decoded image can be suppressed.

Moreover, as shown in the tenth row of the table in FIG. 4, the optical property parameter may include a parameter for a polarizing angle characteristic of incident light (method 1-1-3-2). A polarizing sensor detects incident light having a predetermined polarizing angle formed through a polarizing filter. The polarizing filter is a filter that allows only the passage of light having the predetermined polarizing angle. The polarizing sensor is provided with, for each pixel of the pixel array, the polarizing filter that allows the passage of light having the predetermined polarizing angle.

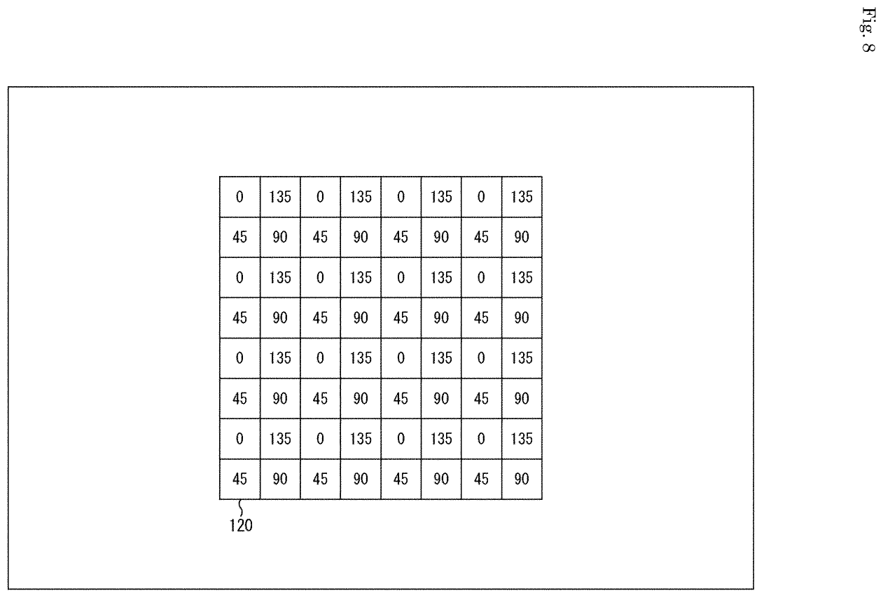

A RAW image 120 shown in FIG. 8 indicates an example of RAW image outputted from a monochrome polarizing sensor provided with a polarizing filter in a pixel array. Each square of the RAW image 120 indicates a pixel value, and a number in each square indicates a polarizing angle of incident light through the polarizing filter. Specifically, the RAW image 120 includes a pixel value indicating the luminance value of incident light having a polarizing angle of 0°, a pixel value indicating the luminance value of incident light having a polarizing angle of 45°, a pixel value indicating the luminance value of incident light having a polarizing angle of 90°, and a pixel value indicating the luminance value of incident light having a polarizing angle of 135°.

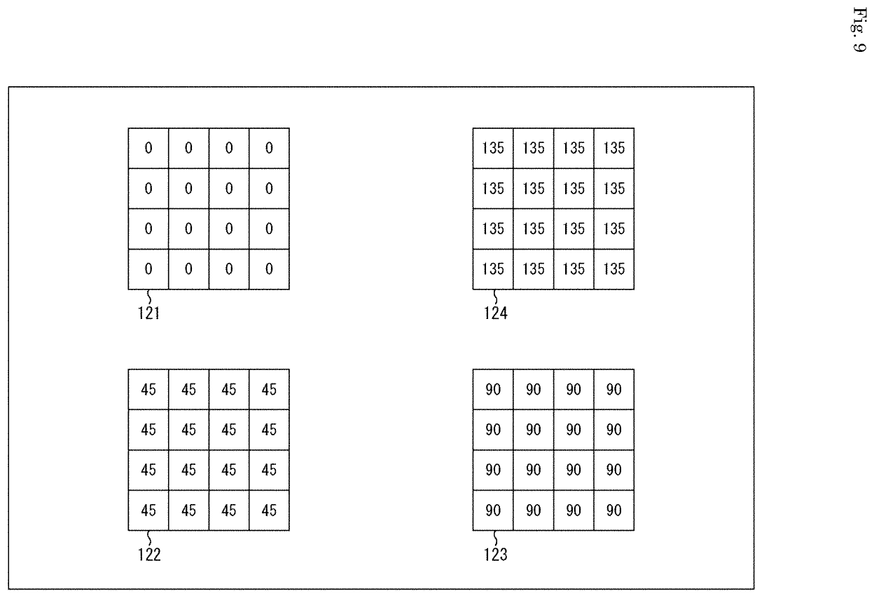

The RAW image 120 configured thus is reconstructed by a polarizing angle length characteristic, so that reconstructed images are obtained as shown in, FIG. 9. In FIG. 9, a reconstructed image 121 is a reconstructed image including a pixel value indicating the luminance value of incident light having a polarizing angle of 0°. A reconstructed image 122 is a reconstructed image including a pixel value indicating the luminance value of incident light having a polarizing angle of 45°. A reconstructed image 123 is a reconstructed image including a pixel value indicating the luminance value of incident light having a polarizing angle of 90°. A reconstructed image 124 is a reconstructed image including a pixel value indicating the luminance value of incident light having a polarizing angle of 135°.

Such a reconstructed image (encoded data thereof) is transmitted and the reconstruction information is transmitted, so that in the event of a transmission error, the receiving device can perform, on the basis of the reconstruction information, error concealing by using a reconstructed image having the same polarizing angle characteristic as data lost by the transmission error (a reconstructed image having the same characteristic value of a polarizing angle characteristic as data lost by the transmission error). Thus, a loss of the subject image quality of a decoded image can be suppressed.

As shown in the eleventh row of the table in FIG. 4, the optical property parameter may include a parameter for a transmission wavelength characteristic that is a wavelength characteristic of incident light and a parameter for a polarizing angle characteristic of incident light (method 1-1-3-3). A color polarizing sensor includes a polarizing filter and a color filter that are provided for each pixel of the pixel array, and the color polarizing sensor detects incident light having a predetermined polarizing angle and a predetermined wave range (color) through the filters.

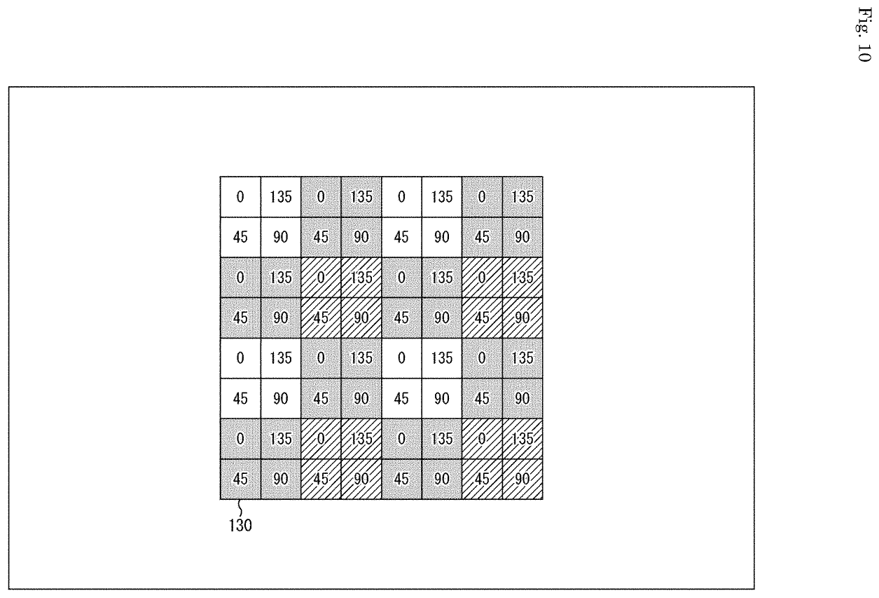

A RAW image 130 shown in FIG. 10 indicates an example of a RAW image outputted from the color image sensor including a polarizing filter and a color filter in a pixel array. Each square of the RAW image 130 indicates a pixel value. A white pixel indicates the pixel value of the wave range of blue (B), a gray pixel indicates the pixel value of the wave range of green (G), and a pixel in a hatch pattern indicates the pixel value of the wave range of red (R). A number in each square indicates a polarizing angle of incident light through the polarizing filter.

Specifically, the RAW image 130 includes pixel values (that is, pixel values for 16 optical property values in total) indicating the luminance values of incident light having four polarizing angles of 0°, 45°, 90°, and 135° for the respective wave ranges of blue (B), green (Gb), green (Gr), and red (R).

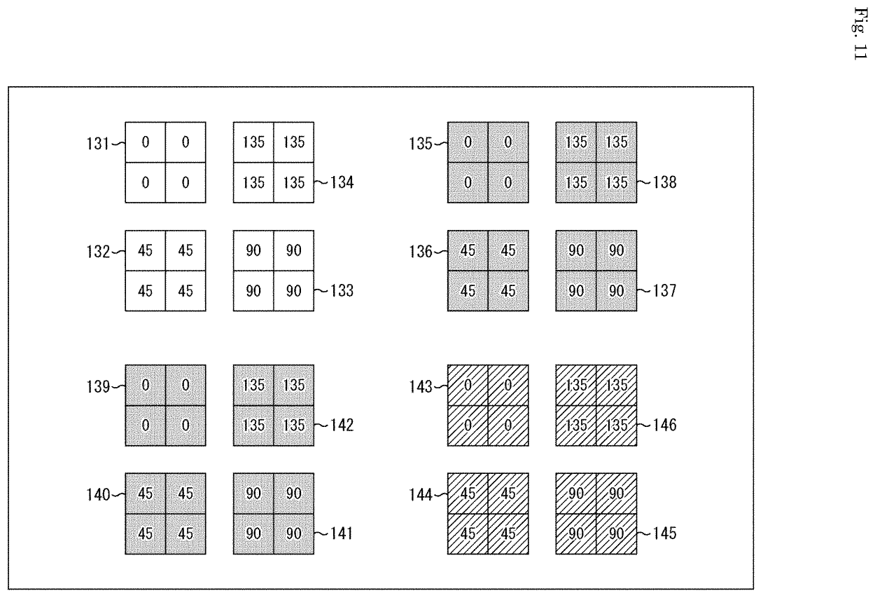

The RAW image 130 configured thus is reconstructed by a transmission wavelength characteristic and a polarizing angle length characteristic, so that reconstructed images are obtained as shown in, for example, FIG. 11. In FIG. 11, a reconstructed image 131 is a reconstructed image including a pixel value indicating the luminance value of the wave range of blue (B) of incident light having a polarizing angle of 0°. A reconstructed image 132 is a reconstructed image including a pixel value indicating the luminance value of the wave range of blue (B) of incident light having a polarizing angle of 45°. A reconstructed image 133 is a reconstructed image including a pixel value indicating the luminance value of the wave range of blue (B) of incident light having a polarizing angle of 90°. A reconstructed image 134 is a reconstructed image including a pixel value indicating the luminance value of the wave range of blue (B) of incident light having a polarizing angle of 135°.

A reconstructed image 135 is a reconstructed image including a pixel value indicating the luminance value of the wave range of green (Gb) of incident light having a polarizing angle of 0°. A reconstructed image 136 is a reconstructed image including a pixel value indicating the luminance value of the wave range of green (Gb) of incident light having a polarizing angle of 45°. A reconstructed image 137 is a reconstructed image including a pixel value indicating the luminance value of the wave range of green (Gb) of incident light having a polarizing angle of 90°. A reconstructed image 138 is a reconstructed image including a pixel value indicating the luminance value of the wave range of green (Gb) of incident light having a polarizing angle of 135°.

A reconstructed image 139 is a reconstructed image including a pixel value indicating the luminance value of the wave range of green (Gr) of incident light having a polarizing angle of 0°. A reconstructed image 140 is a reconstructed image including a pixel value indicating the luminance value of the wave range of green (Gr) of incident light having a polarizing angle of 45°. A reconstructed image 141 is a reconstructed image including a pixel value indicating the luminance value of the wave range of green (Gr) of incident light having a polarizing angle of 90°. A reconstructed image 142 is a reconstructed image including a pixel value indicating the luminance value of the wave range of green (Gr) of incident light having a polarizing angle of 135°.

A reconstructed image 143 is a reconstructed image including a pixel value indicating the luminance value of the wave range of red (R) of incident light having a polarizing angle of 0°. A reconstructed image 144 is a reconstructed image including a pixel value indicating the luminance value of the wave range of red (R) of incident light having a polarizing angle of 45°. A reconstructed image 145 is a reconstructed image including a pixel value indicating the luminance value of the wave range of red (R) of incident light having a polarizing angle of 90°. A reconstructed image 146 is a reconstructed image including a pixel value indicating the luminance value of the wave range of red (R) of incident light having a polarizing angle of 135°.

Such a reconstructed image (encoded data thereof) is transmitted and the reconstruction information is transmitted, so that in the event of a transmission error, the receiving device can perform, on the basis of the reconstruction information, error concealing by using a reconstructed image having the same transmission wavelength characteristic and the same polarizing angle characteristic as data lost by the transmission error (a reconstructed image having the same characteristic values of a transmission wavelength characteristic and a polarizing angle characteristic as data lost by the transmission error). Thus, a loss of the subject image quality of a decoded image can be suppressed.

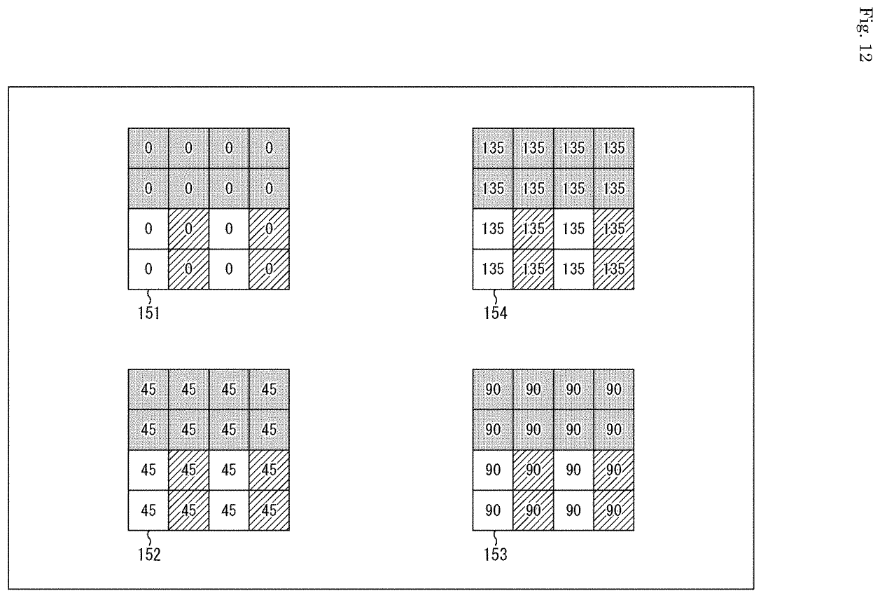

The RAW image 130 in FIG. 10 may be reconstructed by a polarizing angle characteristic to generate reconstructed images as shown in, for example, FIG. 12. In FIG. 12, a reconstructed image 151 is a reconstructed image including a pixel value indicating the luminance value of the wave range of blue (B) of incident light having a polarizing angle of 0°, a pixel value indicating the luminance value of the wave range of green (Gb) of incident light having a polarizing angle of 0°, a pixel value indicating the luminance value of the wave range of green (Gr) of incident light having a polarizing angle of 0°, and a pixel value indicating the luminance value of the wave range of red (R) of incident light having a polarizing angle of 0°. A reconstructed image 152 is a reconstructed image including a pixel value indicating the luminance value of the wave range of blue (B) of incident light having a polarizing angle of 45°, a pixel value indicating the luminance value of the wave range of green (Gb) of incident light having a polarizing angle of 45°, a pixel value indicating the luminance value of the wave range of green (Gr) of incident light having a polarizing angle of 45°, and a pixel value indicating the luminance value of the wave range of red (R) of incident light having a polarizing angle of 45°. A reconstructed image 153 is a reconstructed image including a pixel value indicating the luminance value of the wave range of blue (B) of incident light having a polarizing angle of 90°, a pixel value indicating the luminance value of the wave range of green (Gb) of incident light having a polarizing angle of 90°, a pixel value indicating the luminance value of the wave range of green (Gr) of incident light having a polarizing angle of 90°, and a pixel value indicating the luminance value of the wave range of red (R) of incident light having a polarizing angle of 90°. A reconstructed image 154 is a reconstructed image including a pixel value indicating the luminance value of the wave range of blue (B) of incident light having a polarizing angle of 135°, a pixel value indicating the luminance value of the wave range of green (Gb) of incident light having a polarizing angle of 135°, a pixel value indicating the luminance value of the wave range of green (Gr) of incident light having a polarizing angle of 135°, and a pixel value indicating the luminance value of the wave range of red (R) of incident light having a polarizing angle of 135°.

Such a reconstructed image (encoded data thereof) is transmitted and the reconstruction information is transmitted, so that in the event of a transmission error, the receiving device can perform, on the basis of the reconstruction information, error concealing by using a reconstructed image having the same polarizing angle characteristic as data lost by the transmission error (a reconstructed image having the same characteristic value of a polarizing angle characteristic as data lost by the transmission error). Thus, a loss of the subject image quality of a decoded image can be suppressed.

As shown in the twelfth row of the table in FIG. 4, the optical property parameter may include a parameter for a transmission wavelength characteristic that is a wavelength characteristic of incident light, and the parameter may include a parameter for the position of the pixel (lattice point) for detecting incident light (method 1-1-3-4).

A multispectral image sensor is a sensor designed such that filters with various transmission wavelengths are placed for respective photodiodes and images can be obtained at more wavelengths than in a conventional sensor using three colors of RGB.

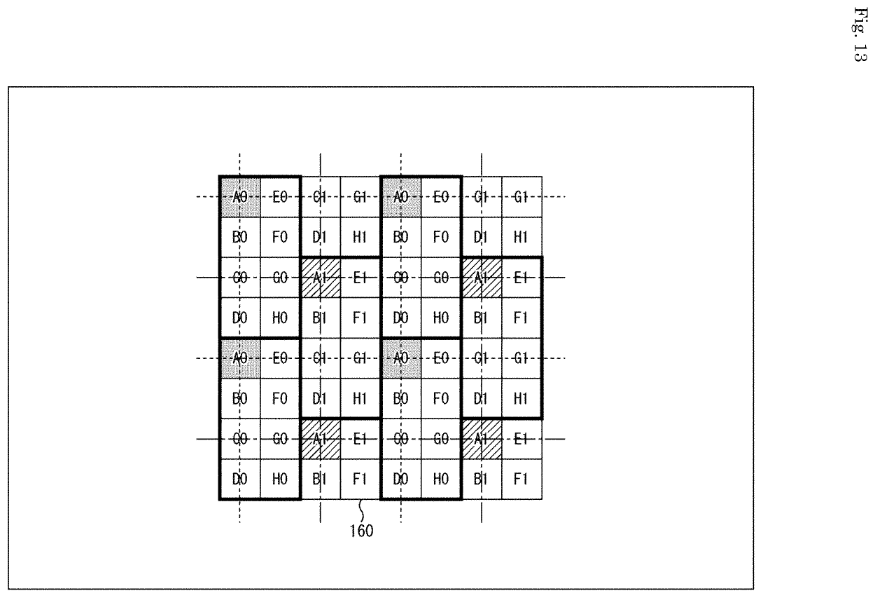

A RAW image 160 in FIG. 13 indicates an example of a RAW image generated by the multispectral image sensor. In FIG. 13, each square in the RAW image 160 indicates a pixel. A to H attached to pixels each indicate an example of the characteristic value of a transmission wavelength characteristic. As shown in FIG. 13, the pixels of the RAW image 160 are placed in a layout pattern in which the pixels of the wave ranges of A to H are placed for each unit group as indicated by thick lines.

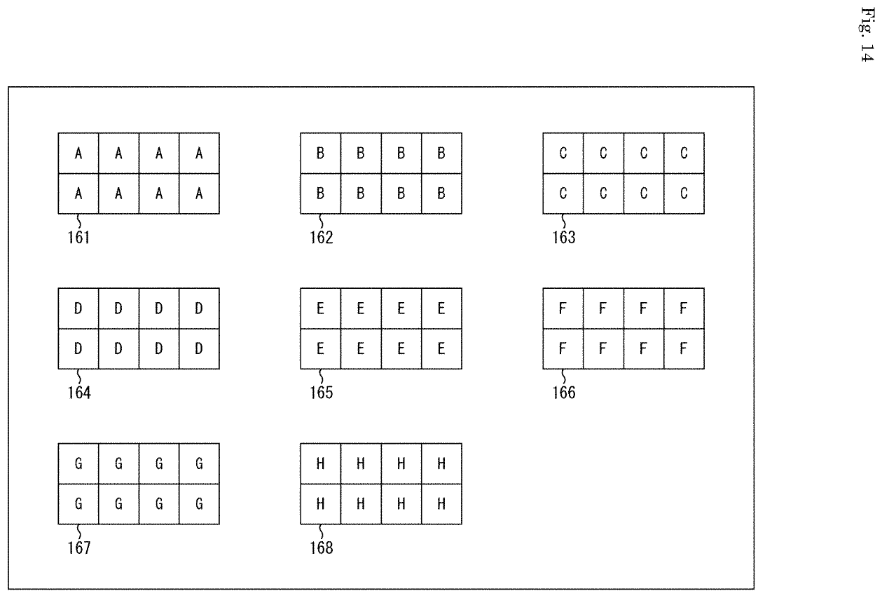

The RAW image 160 in FIG. 13 is reconstructed by a transmission wavelength characteristic, so that reconstructed images are obtained as shown in, for example, FIG. 14. In FIG. 14, a reconstructed image 161 is a reconstructed image including the pixel value of a wave range A. A reconstructed image 162 is a reconstructed image including the pixel value of a wave range B. A reconstructed image 163 is a reconstructed image including the pixel value of a wave range C. A reconstructed image 164 is a reconstructed image including the pixel value of a wave range D. A reconstructed image 165 is a reconstructed image including the pixel value of a wave range E. A reconstructed image 166 is a reconstructed image including the pixel value of a wave range F. A reconstructed image 167 is a reconstructed image including the pixel value of a wave range G. A reconstructed image 168 is a reconstructed image including the pixel value of a wave range H.

Such a reconstructed image (encoded data thereof) is transmitted and the reconstruction information is transmitted, so that in the event of a transmission error, the receiving device can perform, on the basis of the reconstruction information, error concealing by using a reconstructed image having the same transmission wavelength characteristic as data lost by the transmission error (a reconstructed image having the same characteristic value of a transmission wavelength characteristic as data lost by the transmission error). Thus, a loss of the subject image quality of a decoded image can be suppressed.

In the RAW image 160 of FIG. 13, however, unit groups adjacent to each other in the row direction are displaced from each other in the column direction. Thus, like a pixel A0 and a pixel A1 in FIG. 13, two kinds of pixels are displaced from each other in the rows and columns even in the same wave range. The pixel A0 and the pixel A1 configured thus are displaced from each other in the rows and columns, resulting in low correlativity between the pixels.

Thus, an image may be reconstructed by transmission wavelength characteristics and lattice points (pixel positions).

For example, if the pixels A0 and the pixels A1 are to be processed in the example of FIG. 13, the rows and columns of the pixels A0 and the rows and columns of the pixels A1 are connected as indicated by dotted lines and chain lines in FIG. 13, so that a lattice of rectangles (tetragonal lattice) is formed by the dotted lines or the chain lines. For example, the vertexes (lattice points) of the tetragonal lattice formed by the dotted lines are the pixels A0, whereas the vertexes (lattice points) of the tetragonal lattice formed by the chain lines are the pixels A1. Thus, the pixels A0 and the pixels A1 are identified by the lattice points of the tetragonal lattice, and then reconstruction is performed.

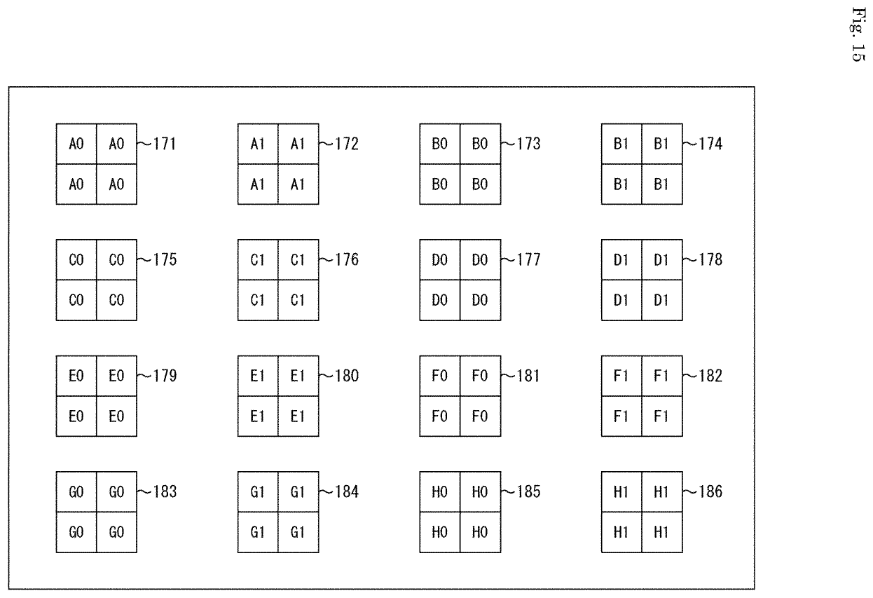

In other words, the pixel values of the RAW image outputted from the multispectral image sensor are reconstructed by the transmission wavelength characteristics and the positions of the pixels, so that a reconstructed image is generated with the pixel values of the pixels that have the same characteristic values of transmission wavelength characteristics of detected incident light and are located at the same position in the row direction or the column direction in the pixel array. In this way, reconstructed images 171 to 186 are generated as shown in FIG. 15.

Such a reconstructed image (encoded data thereof) is transmitted and the reconstruction information is transmitted, so that in the event of a transmission error, the receiving device can perform, on the basis of the reconstruction information, error concealing by using a reconstructed image having the same transmission wavelength characteristic as data lost by the transmission error and having the corresponding pixel position (a reconstructed image that has the same characteristic value of a transmission wavelength characteristic and is located at the same position in the row direction and the column direction in the pixel array as data lost by the transmission error). Thus, a loss of the subject image quality of a decoded image can be suppressed.

For example, as shown in the thirteenth row of the table in FIG. 4, the parameter may include a non-optical property parameter for a property other than an optical property of incident light detected by the sensor (method 1-1-4).

Any parameter may be applied as the non-optical property parameter. For example, as shown in the fourteenth row of the table in FIG. 4, the non-optical property parameter may include scene identification information (scene ID) for identifying the scene of a RAW image (method 1-1-4-1).

For example, in a multi-camera system, a subject is imaged by using multiple cameras disposed at different positions and moving images to be displayed are selected from moving images generated by cameras. In the multi-camera system, the moving images to be displayed (the cameras that generate the moving images) can be switched by a switcher on the time series.

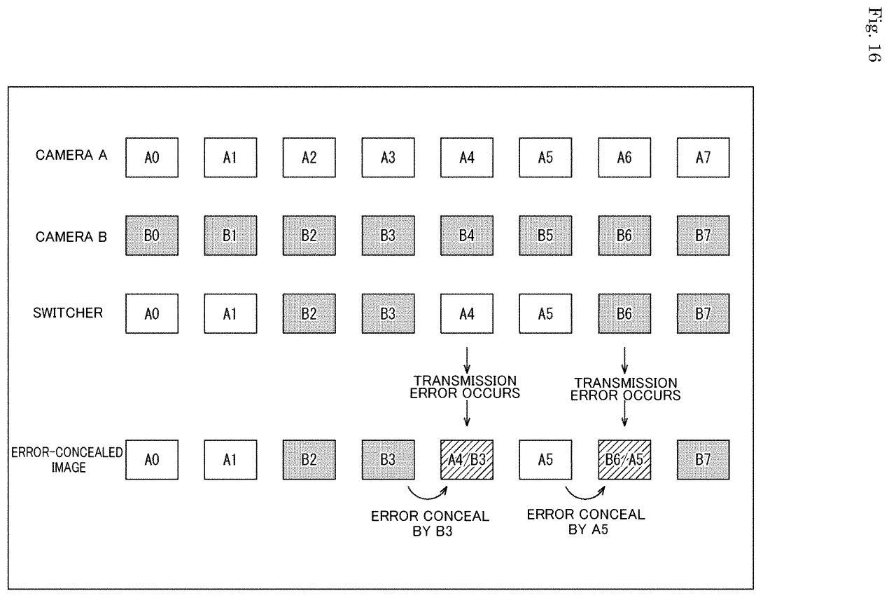

For example, in the case of FIG. 16, a camera A generates a moving image configured with frames A0 to A7. A camera B generates a moving image configured with frames B0 to B7. A switcher selects one of the frames. Specifically, a moving image configured with the frame A0, the frame A1, the frame B2, the frame B3, the frame A4, the frame A5, the frame B6, and the frame B7 is generated and displayed. At this point, the frames captured by one camera form a so-called scene. In other words, scenes are switched by changing the cameras (moving images) by the switcher.

In the transmission of moving images, the switcher may be included in the transmitting device or the receiving device. Specifically, the transmitting device may transmit a selected moving image and the receiving device may display the moving image, or the transmitting device may transmit the moving images of all the cameras and the receiving device may display selected one of the moving images.

In either case, if some of the frames are lost by a transmission error in a combination of moving images captured by the multiple cameras, error concealing is performed in the receiving device. However, in the case of a conventional error concealing method, error concealing is performed by using the image of a preceding frame.

For example, if the frame A4 is partially lost by a transmission error in FIG. 16, data is interpolated by error concealing using the image of the frame B3. Thus, data of the frame B3 is mixed in the frame A4. If the frame B6 is partially lost by a transmission error, data is interpolated by error concealing using the image of the frame A5. Thus, data of the frame A5 is mixed in the frame B6.

However, the cameras are typically located at different imaging positions with different imaging directions and different angle of views, resulting in low correlativity between moving images generated by the cameras. In other words, correlativity between the images of different scenes is low. Hence, the frame having been subjected to error concealing contains images less correlated with each other. This may reduce the subjective image quality.

Thus, as described above, identification information (scene ID) about a scene corresponding to an image is included in the reconstruction information. The transmission of the reconstruction information enables the receiving device to perform, on the basis of the reconstruction information, error concealing by using an image of a frame with the same scene as a frame including lost data.

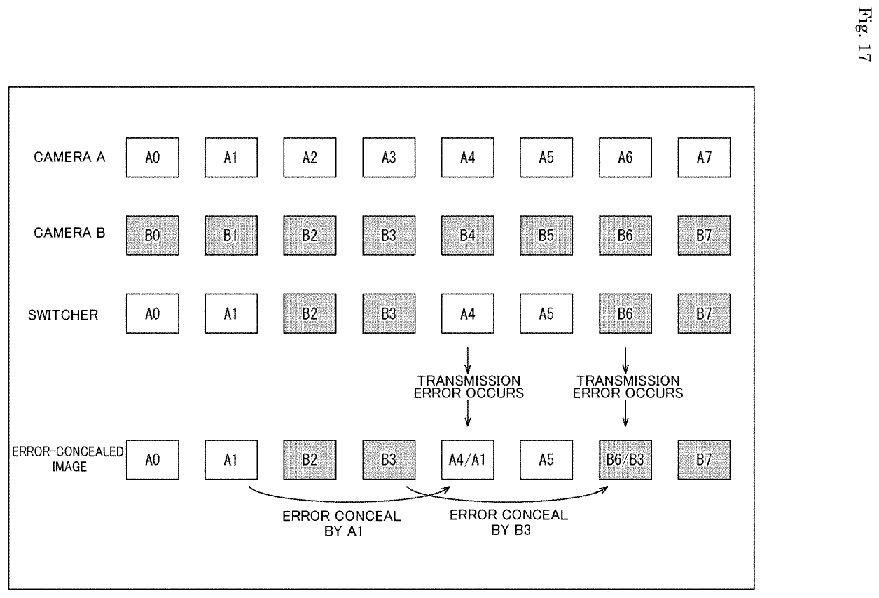

For example, in the case of FIG. 16, the receiving device can perform, on the basis of the reconstruction information, error concealing by using data of the frame A1 with the same scene as the frame A4 as shown in FIG. 17. Moreover, the receiving device can perform, on the basis of the reconstruction information, error concealing by using data of the frame B3 with the same scene as the frame B6 as shown in FIG. 17.

This can suppress mixing of data of multiple scenes in one frame, thereby reducing a loss of the subjective image quality of a decoded image.

This method can be applied in combination with a method of performing error concealing by using a reconstructed image with the same parameter characteristic value. For example, the receiving device may perform error concealing by using a reconstructed image having the same parameter characteristic value as a reconstructed image having a transmission error in a frame preceding a frame to be processed and with the same scene as the frame to be processed. This can further suppress a loss of the subjective image quality of a decoded image.

As described above, the non-optical property parameter may be any parameter. For example, identification information for identifying a region in an image (e.g., a window on a game or computer screen) may be included in the non-optical property parameter.

### <Storage Location of Reconstruction Information>

The reconstruction information may be stored in any location when being transmitted. For example, the information may be transmitted as data (bit stream) different from a reconstructed image or may be included in the bit stream of a reconstructed image when being transmitted.

For example, as shown in the sixteenth row of the table in FIG. 4, the reconstruction information may be transmitted while being stored in SEI (Supplemental Enhancement Information) of encoded data of a reconstructed image (method 1-1-5). In other words, the transmitting unit of the transmitting device may transmit SEI of encoded data of the reconstructed image while the reconstruction information is stored in SEI. For example, the reconstruction information may be transmitted while being stored in User data unregistered SEI. Since the storage location of the reconstruction information is determined in advance, the receiving device can more easily obtain the reconstruction information from received data.

### <Generation and Transmission Timing of Reconstruction Information>

With any timing, the reconstruction information generating unit of the transmitting device generates the foregoing reconstruction information and the transmitting unit transmits the reconstruction information.

For example, as shown in the eighteenth row of the table in FIG. 4, the reconstruction information generating unit of the transmitting device may generate the reconstruction information in the first frame as information to be applied to all of the frames (method 1-1-6). The transmitting unit may transmit the reconstruction information before transmitting the reconstructed image of the first frame. Moreover, the transmitting unit may transmit the reconstruction information included in the bit stream of the reconstructed image.

Thus, the receiving device can perform error concealing on data of all the frames by using the received reconstruction information. Accordingly, an increase in the amount of data transmission can be suppressed when the reconstruction information is transmitted.

For example, as shown in the nineteenth row of the table in FIG. 4, the reconstruction information generating unit of the transmitting device may generate the reconstruction information for each frame (method 1-1-7). In other words, in this case, the reconstruction information generating unit generates the reconstruction information in each frame as information to be applied only to each frame. The transmitting unit may transmit the reconstruction information of each frame before transmitting the reconstructed image of each frame. Moreover, the transmitting unit may transmit the reconstruction information corresponding to each frame while the reconstruction information is included in the bit stream of the reconstructed image of each frame.

This can change the method of reconstruction in any frame without changing the method of generating/transmitting the reconstruction information. In other words, even if the method of reconstruction is changed, the transmitting device and the receiving device can be more easily controlled.

For example, as shown in the twentieth row of the table in FIG. 4, the reconstruction information generating unit of the transmitting device may generate the reconstruction information in the frame where the method of reconstruction is changed (method 1-1-8). In other words, in this case, the reconstruction information generating unit generates the reconstruction information in a frame where the method of reconstruction is changed, as information to be applied to the frames from the current frame to the frame preceding the frame where the method of reconstruction is to be subsequently changed. The transmitting unit may transmit the reconstruction information before transmitting the reconstructed image of the frame where the reconstruction information is generated. Moreover, the transmitting unit may transmit the reconstruction information included in the bit stream of the reconstructed image of the frame where the reconstruction information is generated.

This can change the method of reconstruction in any frame. Accordingly, an increase in the amount of data transmission in the transmission of the reconstruction information can be more suppressed than in the transmission of the reconstruction information generated for each frame.

### <Reconstruction Method>

A RAW image is reconstructed by any method. As described above, the reconstructing unit of the transmitting device may reconstruct a RAW image by using any parameter.

For example, as shown in the twenty second row of the table in FIG. 4, the reconstructing unit of the transmitting device may reconstruct a RAW image according to a specific optical property (method 1-1-9). In other words, the reconstructing unit may reconstruct a RAW image in each frame according to a predetermined method shared among all of the frames and generate a reconstructed image.

Moreover, as shown in the twenty third row of the table in FIG. 4, the reconstructing unit of the transmitting device may reconstruct a RAW image according to any optical property (method 1-1-10). In other words, the reconstructing unit may reconstruct a RAW image in each frame according to any method and generate a reconstructed image. That is to say, the reconstructing unit may change the method of reconstruction (e.g., a parameter used for reconstruction) during a moving image.

For example, if a RAW image can be reconstructed by using multiple kinds of optical properties, the reconstructing unit may reconstruct the image by using some of the optical properties or reconstruct the image by using all the optical properties. In the case of a moving image, the reconstructing unit may change the method of reconstruction in intermediate one of the frames.

For example, as described above, a RAW image outputted from the color polarizing sensor can be reconstructed by using transmission wavelength characteristics and polarizing angle characteristics. In this case, the reconstructing unit may reconstruct the RAW image by using only transmission wavelength characteristics, by using only polarizing angle characteristics, or by using transmission wavelength characteristics and polarizing angle characteristics.

Furthermore, as described above, a RAW image outputted from the multispectral image sensor can be reconstructed by using transmission wavelength characteristics and lattice points (the positions of the pixels). In this case, the reconstructing unit may reconstruct the RAW image by using only transmission wavelength characteristics or by using transmission wavelength characteristics and lattice points (the positions of the pixels).

### <Encoding of Reconstruction Information>

For example, as shown in the bottom row of the table in FIG. 4, the reconstruction information may be encoded and the encoded data may be transmitted (method 1-1-11). In other words, the encoding unit of the transmitting device may encode the reconstruction information to generate encoded data, and then the transmitting unit may transmit the encoded data of the reconstruction information.

Accordingly, an increase in the amount of data transmission in the transmission of the reconstruction information can be more suppressed than in the transmission of the reconstruction information without encoding.

### <2-2. Reception of Reconstruction Information and Error Concealing>

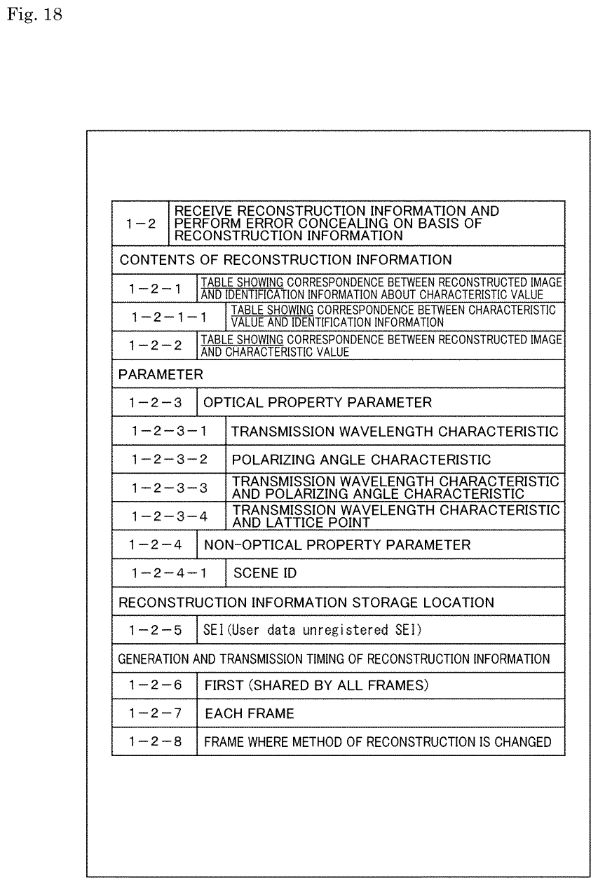

As shown in the uppermost row of a table in FIG. 18, the receiving unit of the receiving device, which receives the reconstructed image, receives the reconstruction information. The reconstruction information is information that corresponds to a reconstructed image obtained by reconstructing a RAW image by using a predetermined parameter and identifies the value of the parameter applied to the reconstruction. The concealing unit of the receiving device then performs error concealing on the basis of the reconstruction information (method 1-2).

For example, in an information processing method, reconstruction information may be received and a transmission error of a reconstructed image may be concealed on the basis of the received reconstruction information. The reconstruction information corresponds to the reconstructed image obtained by reconstructing a RAW image by using a predetermined parameter and identifies the value of the parameter, the RAW image being outputted from a sensor for detecting incident light in each pixel of the pixel array.

For example, the information processing device may include a receiving unit configured to receive reconstruction information that corresponds to a reconstructed image obtained by reconstructing a RAW image by using a predetermined parameter and identifies the value of the parameter, the RAW image being outputted from the sensor for detecting incident light in each pixel of the pixel array, and a concealing unit that conceals a transmission error of the reconstructed image on the basis of the reconstruction information.

With this configuration, the receiving device can identify the component of the received reconstructed image (the value of the parameter used for reconstruction) on the basis of the reconstruction information. In other words, in the event of a transmission error, the receiving device can identify the component of data lost by the transmission error, on the basis of the reconstruction information.

Thus, the receiving device performs error concealing on the basis of the reconstruction information, so that as shown in FIG. 5, error concealing can be performed by using a reconstructed image with the same component (parameter value) as lost data in a received frame (a frame preceding a frame to be processed).

As described above, the receiving device can suppress the generation of a reconstructed image including a pixel value of an improper wave range (color) through error concealing. Thus, a loss of the subjective image quality of a decoded image (captured image) can be suppressed.

The receiving device can basically use, for error concealing, a reconstructed image of any frame from among frames preceding a frame to be processed (that is, received frames) unless data is discarded. When data of an old frame is discarded, the receiving device can perform error concealing by using a reconstructed image of any frame among the held frames.

Typically, the closer to the frame to be processed, the higher the correlativity with the frame to be processed. Thus, the receiving device may perform error concealing by using a reconstructed image of the frame (previously received frame) preceding the frame to be processed. This allows the receiving device to suppress a reduction in prediction accuracy. In other words, the receiving device can suppress a reduction in encoding efficiency.

### <Contents of Reconstruction Information>

The reconstruction information will be described below. The reconstruction information may contain any contents. For example, as shown in the third row of the table in FIG. 18, the reconstruction information may include information about a correlation between a reconstructed image and identification information about a parameter value (characteristic value) (method 1-2-1).

Generally, an information amount of identification information can be smaller than a parameter value. Thus, an increase in the information amount of the reconstruction information can be suppressed by using the identification information instead of a parameter value.

The identification information about a parameter value may be information known to the transmitting device and the receiving device. In this case, it is not necessary to transmit information about the correspondence between each piece of the identification information and a parameter value. Thus, an increase in the information amount of the reconstruction information can be suppressed.

As shown in the fourth row of the table in FIG. 18, the reconstruction information may further include information about a correlation between a parameter value (characteristic value) and identification information (method 1-2-1-1). In this case, the receiving device specifies a reconstructed image to be applied to error concealing, on the basis of information about a correlation between a reconstructed image and identification information about a parameter value and information about a correlation between a parameter value and the identification information, the information being included in the reconstruction information. In other words, identification information unknown to the receiving device can be used.

As shown in the fifth row of the table in FIG. 18, the reconstruction information may include information about a correlation between a reconstructed image and a parameter value (method 1-2-2).

### <Parameter>

Any sensor may be used for generating a RAW image, and any parameter may be used for reconstruction. For example, as shown in the seventh row of the table in FIG. 18, the parameter may include an optical property parameter for an optical property of incident light detected by the sensor (method 1-2-3).

For example, as shown in the eighth row of the table in FIG. 18, the optical property parameter may include a parameter for a transmission wavelength characteristic that is a wavelength characteristic of incident light (method 1-2-3-1).

The reconstructed images 111 to 114 as shown in FIG. 7 and reconstruction information for the reconstruction may be transmitted. The reconstructed images 111 to 114 are obtained by reconstructing the RAW image 110 (FIG. 6), which is outputted from the color image senor, by using transmission wavelength characteristics (RGB).

In the event of a transmission error, the receiving device performs, on the basis of the reconstruction information, error concealing by using a reconstructed image having the same transmission wavelength characteristic as data lost by the transmission error (a reconstructed image having the same characteristic value of a transmission wavelength characteristic as data lost by the transmission error). Thus, a loss of the subject image quality of a decoded image can be suppressed.

Moreover, as shown in the ninth row of the table in FIG. 18, the optical property parameter may include a parameter for a polarizing angle characteristic of incident light (method 1-2-3-2).

For example, the reconstructed images 121 to 124 as shown in FIG. 9 and reconstruction information for the reconstruction may be transmitted. The reconstructed images 121 to 124 are obtained by reconstructing the RAW image 120 (FIG. 8), which is outputted from the monochrome polarizing senor, by using polarizing angle length characteristics.

In the event of a transmission error, the receiving device performs, on the basis of the reconstruction information, error concealing by using a reconstructed image having the same polarizing angle characteristic as data lost by the transmission error (a reconstructed image having the same characteristic value of a polarizing angle characteristic as data lost by the transmission error). Thus, a loss of the subject image quality of a decoded image can be suppressed.

As shown in the tenth row of the table in FIG. 18, the optical property parameter may include a parameter for a transmission wavelength characteristic that is a wavelength characteristic of incident light and a parameter for a polarizing angle characteristic of incident light (method 1-2-3-3).

For example, the reconstructed images 131 to 146 as shown in FIG. 11 and reconstruction information for the reconstruction may be transmitted. The reconstructed images 131 to 146 are obtained by reconstructing the RAW image 130 (FIG. 10), which is outputted from the color polarizing senor, by using transmission wavelength characteristics and polarizing angle length characteristics.

In the event of a transmission error, the receiving device performs, on the basis of the reconstruction information, error concealing by using a reconstructed image having the same transmission wavelength characteristic and the same polarizing angle characteristic as data lost by the transmission error (a reconstructed image having the same characteristic values of a transmission wavelength characteristic and a polarizing angle characteristic as data lost by the transmission error). Thus, a loss of the subject image quality of a decoded image can be suppressed.

The RAW image 130 of FIG. 10 may be reconstructed by using polarizing angle characteristics, and the reconstructed images 151 to 154 shown in FIG. 12 and reconstruction information for the reconstruction may be transmitted.

In the event of a transmission error, the receiving device performs, on the basis of the reconstruction information, error concealing by using a reconstructed image having the same polarizing angle characteristic as data lost by the transmission error (a reconstructed image having the same characteristic value of a polarizing angle characteristic as data lost by the transmission error). Thus, a loss of the subject image quality of a decoded image can be suppressed.

As shown in the eleventh row of the table in FIG. 18, the optical property parameter may include a parameter for a transmission wavelength characteristic that is a wavelength characteristic of incident light, and the parameter may include a parameter for the position of the pixel (lattice point) for detecting incident light (method 1-2-3-4).

The reconstructed images 161 to 168 as shown in FIG. 14 and reconstruction information for the reconstruction may be transmitted. The reconstructed images 161 to 168 are obtained by reconstructing the RAW image 160 (FIG. 13), which is outputted from the multispectral image senor, by using transmission wavelength characteristics.

In the event of a transmission error, the receiving device performs, on the basis of the reconstruction information, error concealing by using a reconstructed image having the same transmission wavelength characteristic as data lost by the transmission error (a reconstructed image having the same characteristic value of a transmission wavelength characteristic as data lost by the transmission error). Thus, a loss of the subject image quality of a decoded image can be suppressed.

In the RAW image 160 of FIG. 13, however, unit groups adjacent to each other in the row direction are displaced from each other in the column direction. Thus, like the pixel A0 and the pixel A1 in FIG. 13, two kinds of pixels are displaced from each other in the rows and columns even in the same wave range. The pixel A0 and the pixel A1 configured thus are displaced from each other in the rows and columns, resulting in low correlativity between the pixels.

Thus, an image may be reconstructed by transmission wavelength characteristics and lattice points (pixel positions).

For example, the reconstructed images 171 to 186 as shown in FIG. 15 and reconstruction information for the reconstruction may be transmitted. The reconstructed images 171 to 186 are obtained by reconstructing the RAW image 160 (FIG. 13), which is outputted from the multispectral image senor, by using transmission wavelength characteristics and pixel positions (lattice points). The reconstructed images are configured with the pixel values of the pixels that have the same characteristic values of transmission wavelength characteristics of detected incident light and are located at the same position in the row direction or the column direction in the pixel array.

In the event of a transmission error, the receiving device performs, on the basis of the reconstruction information, error concealing by using a reconstructed image having the same transmission wavelength characteristic as data lost by the transmission error and having the corresponding pixel position (a reconstructed image that has the same characteristic value of a transmission wavelength characteristic and is located at the same position in the row direction and the column direction in the pixel array as data lost by the transmission error). Thus, a loss of the subject image quality of a decoded image can be suppressed.

For example, as shown in the twelfth row of the table in FIG. 18, the parameter may include a non-optical property parameter for a property other than an optical property of incident light detected by the sensor (method 1-2-4).

Any parameter may be applied as the non-optical property parameter. For example, as shown in the thirteenth row of the table in FIG. 18, the non-optical property parameter may include scene identification information (scene ID) for identifying the scene of a RAW image (method 1-2-4-1).

In other words, the reconstruction information including the scene identification information is transmitted. Thus, as shown in FIG. 17, the receiving device can perform error concealing on the basis of the reconstruction information by using an image of a frame with the same scene as a frame including lost data. This can suppress mixing of data of multiple scenes in one frame, thereby reducing a loss of the subjective image quality of a decoded image.

This method can be applied in combination with a method of performing error concealing by using a reconstructed image with the same parameter characteristic value. For example, the receiving device may perform error concealing by using a reconstructed image having the same parameter characteristic value as a reconstructed image having a transmission error in a frame preceding a frame to be processed and with the same scene as the frame to be processed. This can further suppress a loss of the subjective image quality of a decoded image.

As described above, the non-optical property parameter may be any parameter. For example, identification information for identifying a region in an image (e.g., a window on a game or computer screen) may be included in the non-optical property parameter.

### <Storage Location of Reconstruction Information>

The reconstruction information may be stored in any location when being transmitted. For example, the reconstruction information may be transmitted as data (bit stream) different from a reconstructed image or may be included in the bit stream of a reconstructed image when being transmitted.

For example, as shown in the fifteenth row of the table in FIG. 18, the reconstruction information may be transmitted while being stored in SEI of encoded data of a reconstructed image (method 1-2-5). In other words, the receiving unit of the receiving device may receive SEI of encoded data of the reconstructed image while the reconstruction information is stored in SEI. For example, the reconstruction information may be transmitted while being stored in User data unregistered SEI. Since the storage location of the reconstruction information is determined in advance, the receiving device can more easily obtain the reconstruction information from received data.

### <Reception Timing of Reconstruction Information>

As described above, with any timing, the reconstruction information generating unit of the transmitting device generates the foregoing reconstruction information and the transmitting unit transmits the reconstruction information. In short, the receiving device receives the foregoing reconstruction information with any timing.

For example, as shown in the seventeenth row of the table in FIG. 18, the receiving unit of the receiving device may receive, in the first frame, reconstruction information to be applied to all of the frames (method 1-2-6).

Thus, the receiving device can perform error concealing on data of all the frames by using the received reconstruction information. Accordingly, an increase in the amount of data transmission can be suppressed when the reconstruction information is transmitted.

For example, as shown in the eighteenth row of the table in FIG. 18, the receiving unit of the receiving device may receive the reconstruction information for each frame (method 1-2-7). In other words, in this case, the receiving unit receives the reconstruction information in each frame as information to be applied only to each frame.

This can change the method of reconstruction in any frame without changing the method of receiving the reconstruction information. In other words, even if the method of reconstruction is changed, the transmitting device and the receiving device can be more easily controlled.

For example, as shown in the bottom row of the table in FIG. 18, the receiving unit of the receiving device may receive the reconstruction information in the frame where the method of reconstruction is changed (method 1-2-8). In other words, in this case, the receiving unit receives the reconstruction information in the frame where the method of reconstruction is changed, the reconstruction information being applied to the frames from the current frame to the frame preceding the frame where the method of reconstruction is to be subsequently changed.

This can change the method of reconstruction in any frame. Accordingly, an increase in the amount of data transmission in the transmission of the reconstruction information can be more suppressed than in the transmission of the reconstruction information for each frame.

### <Error Concealing Method>

The concealing unit of the receiving device performs error concealing on the basis of the reconstruction information received by the receiving unit. Any concealing method may be used.

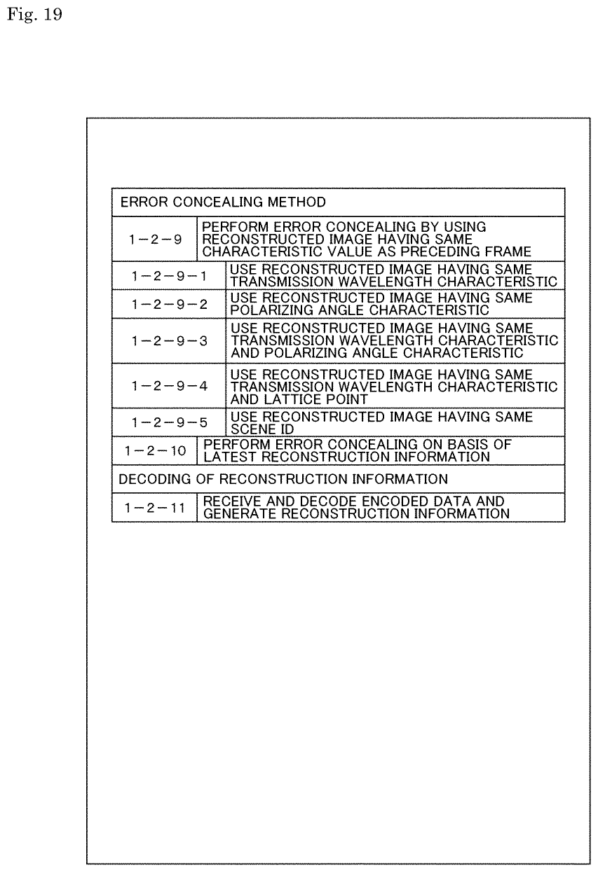

For example, as shown in the second row of the table in FIG. 19, the concealing unit of the receiving device may be configured to perform error concealing (conceal a transmission error of the reconstructed image to be processed) by using the reconstructed image having the same parameter value (characteristic value) as the reconstructed image to be processed, in the frame preceding the frame to be processed (method 1-2-9).

For example, as shown in the third row of the table in FIG. 19, the concealing unit of the receiving device may perform error concealing by using the reconstructed image having the same transmission wave characteristic as the reconstructed image to be processed, in the frame preceding the frame to be processed (method 1-2-9-1).

For example, as shown in the fourth row of the table in FIG. 19, the concealing unit of the receiving device may perform error concealing by using the reconstructed image having the same polarizing angle characteristic as the reconstructed image to be processed, in the frame preceding the frame to be processed (method 1-2-9-2).

For example, as shown in the fifth row of the table in FIG. 19, the concealing unit of the receiving device may perform error concealing by using the reconstructed image having the same transmission wavelength characteristic and polarizing angle characteristic as the reconstructed image to be processed, in the frame preceding the frame to be processed (method 1-2-9-3).

For example, as shown in the sixth row of the table in FIG. 19, the concealing unit of the receiving device may perform error concealing by using the reconstructed image having the same transmission wave characteristic and pixel position for the detection of incident light as the reconstructed image to be processed, in the frame preceding the frame to be processed (method 1-2-9-4).

For example, as shown in the seventh row of the table in FIG. 19, the concealing unit of the receiving device may perform error concealing by using the reconstructed image having the same scene identification information for the scene identification of a RAW image as the reconstructed image to be processed, in the frame preceding the frame to be processed (method 1-2-9-5).

For example, as shown in the eighth row of the table in FIG. 19, the concealing unit of the receiving device may perform error concealing on the basis of the last reconstruction information (that is, the latest reconstruction information) received by the receiving unit (method 1-2-10).

### <Decoding of Reconstruction Information>

For example, as shown in the bottom row of the table in FIG. 19, the receiving unit of the receiving device may receive the encoded data of the reconstruction information and the decoding unit may decode the encoded data to generate (reconstitute) the reconstruction information (method 1-2-11).

Accordingly, an increase in the amount of data transmission in the transmission of the reconstruction information can be more suppressed than in the transmission of the reconstruction information without encoding.

### 3. First Embodiment

### <Sensor Data Transmit/Receive System>

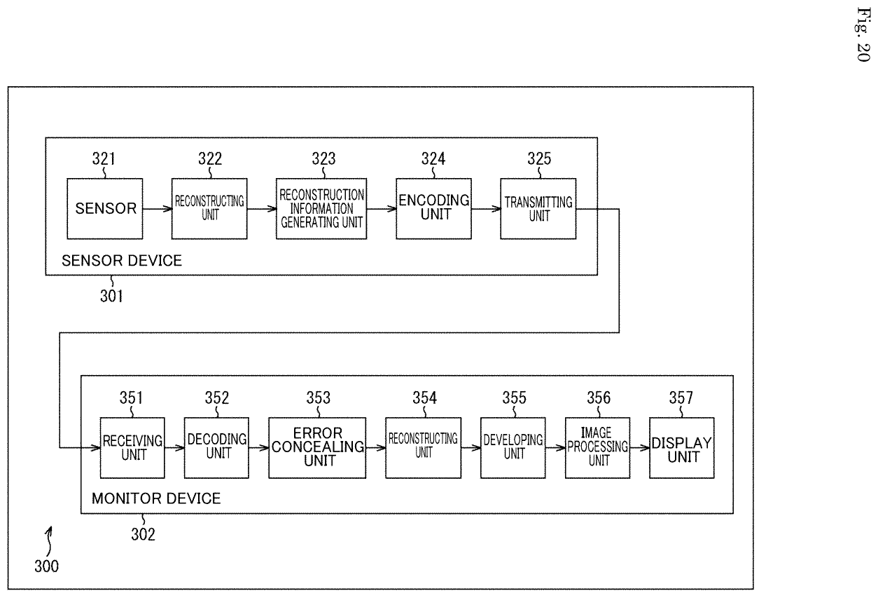

A system to which the foregoing present technique is applied will be described below. FIG. 20 is a block diagram illustrating an example of the configuration of a sensor data transmit/receive system. A sensor data transmit/receive system 300 illustrated in FIG. 20 is an information processing system that includes a sensor device 301 and a monitor device 302 and transmits, to the monitor device 302, sensor data detected in the sensor device 301.

The sensor device 301 is an aspect of an information processing device to which the present technique is applied. The sensor device 301 is a device that generates sensor data by using a sensor and transmits the sensor data to the monitor device 302. The monitor device 302 is a device that receives the sensor data transmitted from the sensor device 301 and displays the sensor data.

### <Sensor Device>

As illustrated in FIG. 20, the sensor device 301 includes a sensor 321, a reconstructing unit 322, a reconstruction information generating unit 323, an encoding unit 324, and a transmitting unit 325.

The sensor 321 has a pixel array including a plurality of pixels for detecting incident light and generates a RAW image by using pixel data detected in each pixel of the pixel array. The sensor 321 supplies the generated RAW image as sensor data to the reconstructing unit 322.

The sensor device 301 may include a plurality of sensors 321. In this case, the sensor device 301 may use, for example, a switcher or the like to select a RAW image to be transmitted from RAW images supplied from the sensors 321 (that is, to supply the selected RAW image to the reconstructing unit 322).

The reconstructing unit 322 reconstructs, by using a predetermined parameter, the RAW image outputted from the sensor 321 and generates a reconstructed image.

As described in <Reconstruction method> of <2-1. Generation and transmission of reconstruction information>, a RAW image is reconstructed by any method. For example, any parameter may be applied to reconstruction. Moreover, the reconstructing unit 322 may reconstruct a RAW image in each frame according to a predetermined method shared among all of the frames and generate a reconstructed image. Furthermore, the reconstructing unit 322 may reconstruct a RAW image according to any method and generate a reconstructed image.

The reconstructing unit 322 supplies the generated reconstructed image as sensor data to the reconstruction information generating unit 323.

The reconstruction information generating unit 323 generates reconstruction information corresponding to the reconstructed image supplied from the reconstructing unit 322. In other words, the reconstruction information generating unit 323 generates information for identifying the value of a parameter (characteristic value) used for the reconstruction. At this point, the reconstruction information generating unit 323 generates the reconstruction information according to the present technique described in <2-1. Generation and transmission of reconstruction information>.

In other words, the reconstruction information generating unit 323 generates reconstruction information that corresponds to a reconstructed image obtained by reconstructing a RAW image by using a predetermined parameter and identifies the value of the parameter, the RAW image being outputted from the sensor for detecting incident light in each pixel of the pixel array.

As described in <Contents of reconstruction information> of <2-1. Generation and transmission of reconstruction information>, the reconstruction information may contain any contents. For example, the reconstruction information may include information about a correlation between the reconstructed image and identification information about the value of a parameter applied to the reconstruction. Moreover, the reconstruction information may further include information about a correlation between the parameter value and identification information. The reconstruction information may also include information about a correlation between a reconstructed image and the value of a parameter applied to the reconstruction.

As described in <Parameter> of <2-1. Generation and transmission of reconstruction information>, a RAW image may be generated by any sensor and any parameter may be used for reconstruction. For example, the parameter may include an optical property parameter for an optical property of incident light detected by the sensor. For example, the optical property parameter may include a parameter for a transmission wavelength characteristic that is a wavelength characteristic of incident light. Moreover, the optical property parameter may include a parameter for a polarizing angle characteristic of incident light.

A plurality of optical property parameters may be provided. For example, the optical property parameter may include a parameter for a transmission wavelength characteristic that is a wavelength characteristic of incident light and a parameter for a polarizing angle characteristic of incident light.

In other words, a plurality of parameters may be used for reconstruction. For example, the parameter may include a parameter for a transmission wavelength characteristic that is a wavelength characteristic of incident light and a parameter for the position of the pixel for detecting incident light.

Furthermore, the parameter used for reconstruction may include a non-optical property parameter for a property other than an optical property of incident light detected by the sensor. For example, the non-optical parameter may include scene identification information for identifying the scene of a RAW image.

As described in <Generation and transmission timing of reconstruction information> of <2-1. Generation and transmission of reconstruction information>, the reconstruction information may be generated and transmitted with any timing. For example, the reconstruction information generating unit 323 may generate the reconstruction information in the first frame as information to be applied to all of the frames. Moreover, the reconstruction information generating unit 323 may generate the reconstruction information in each frame as information to be applied only to each frame. Furthermore, the reconstruction information generating unit 323 may generate the reconstruction information in a frame where the method of reconstruction is changed, as information to be applied to the frames from the current frame to the frame preceding the frame where the method of reconstruction is to be subsequently changed.

The reconstruction information generating unit 323 supplies the reconstructed image and the generated reconstruction information as sensor data to the encoding unit 324.

The encoding unit 324 encodes the reconstructed image supplied from the reconstruction information generating unit 323 and generates encoded data. Any encoding method may be used. The encoding unit 324 stores the reconstruction information in the encoded data. As described in <Storage location of reconstruction information> of <2-1. Generation and transmission of reconstruction information>, the encoding unit 324 may store the reconstruction information in SEI of the encoded data of the reconstructed image. Moreover, as described in <Encoding of reconstruction information> of <2-1. Generation and transmission of reconstruction information>, the reconstruction information may be encoded and encoded data thereof may be generated. The encoding unit 324 supplies the generated encoded data as sensor data to the transmitting unit 325.

The transmitting unit 325 transmits the encoded data (including the reconstruction information) of the reconstructed image as sensor data to the monitor device 302, the encoded data being supplied from the encoding unit 324. At this point, the transmitting unit 325 transmits the reconstruction information according to the present technique described in <2-1. Generation and transmission of reconstruction information>. Any method may be used to transmit the reconstruction information. For example, as described in <Storage location of reconstruction information> of <2-1. Generation and transmission of reconstruction information>, the transmitting unit 325 may transmit SEI of the encoded data of the reconstructed image, the reconstruction information being stored in SEI. Moreover, as described in <Encoding of reconstruction information> of <2-1. Generation and transmission of reconstruction information>, the transmitting unit 325 may transmit encoded data of the reconstruction information.

The provision of such a configuration allows the sensor device 301 to suppress a loss of the subjective image quality of a decoded image.

### <Monitor Device>

As shown in FIG. 20, the monitor device 302 includes a receiving unit 351, a decoding unit 352, an error concealing unit 353, a reconstructing unit 354, a developing unit 355, an image processing unit 356, and a display unit 357.

The receiving unit 351 receives sensor data (encoded data of the reconstructed image, including the reconstruction information) transmitted from the sensor device 301. At this point, the receiving unit 351 receives at least the reconstruction information according to the present technique described in <2-2. Reception of reconstruction information and error concealing>.

In other words, the receiving unit 351 receives the reconstruction information that corresponds to a reconstructed image obtained by reconstructing a RAW image by using a predetermined parameter and identifies the value of the parameter, the RAW image being outputted from the sensor for detecting incident light in each pixel of the pixel array.

As described in <Contents of reconstruction information> of <2-2. Reception of reconstruction information and error concealing>, the reconstruction information may contain any contents. For example, the reconstruction information may include information about a correlation between the reconstructed image and identification information about the value of a parameter applied to the reconstruction. Moreover, the reconstruction information may further include information about a correlation between the parameter value and identification information. The reconstruction information may also include information about a correlation between a reconstructed image and the value of a parameter applied to the reconstruction.

As described in <Parameter> of <2-2. Reception of reconstruction information and error concealing>, a RAW image may be generated by any sensor and any parameter may be used for reconstruction. For example, the parameter may include an optical property parameter for an optical property of incident light detected by the sensor. For example, the optical property parameter may include a parameter for a transmission wavelength characteristic that is a wavelength characteristic of incident light. Moreover, the optical property parameter may include a parameter for a polarizing angle characteristic of incident light.

A plurality of optical property parameters may be provided. For example, the optical property parameter may include a parameter for a transmission wavelength characteristic that is a wavelength characteristic of incident light and a parameter for a polarizing angle characteristic of incident light.

In other words, a plurality of parameters may be used for reconstruction. For example, the parameter may include a parameter for a transmission wavelength characteristic that is a wavelength characteristic of incident light and a parameter for the position of the pixel for detecting incident light.

Furthermore, the parameter used for reconstruction may include a non-optical property parameter for a property other than an optical property of incident light detected by the sensor. For example, the non-optical parameter may include scene identification information for identifying the scene of a RAW image.

As described in <Reception timing of reconstruction information> of <2-2. Reception of reconstruction information and error concealing>, the reconstruction information may be received with any timing. For example, the receiving unit 351 may receive the reconstruction information in the first frame as information to be applied to all of the frames. Moreover, the receiving unit 351 may receive the reconstruction information in each frame as information to be applied only to each frame. Furthermore, the receiving unit 351 may receive the reconstruction information in a frame where the method of reconstruction is changed, as information to be applied to the frames from the current frame to the frame preceding the frame where the method of reconstruction is to be subsequently changed.

The receiving unit 351 supplies the received data to the decoding unit 352.

The decoding unit 352 decodes the encoded data received in the receiving unit 351 and generates (reconstitutes) the reconstructed image and the reconstruction information. Any decoding method may be used. At this point, the decoding unit 352 extracts the reconstruction information stored in the encoded data. As described in <Storage location of reconstruction information> of <2-2. Reception of reconstruction information and error concealing>, the reconstruction information may be stored in SEI of the encoded data of the reconstructed image. In other words, the receiving unit 351 may receive SEI of the encoded data of the reconstructed image while the reconstruction information is stored in SEI, and the decoding unit 352 may extract the reconstruction information from SEI.

Moreover, as described in <Decoding of reconstruction information> of <2-2. Reception of reconstruction information and error concealing>, the reconstruction information may be decoded. In other words, the receiving unit 351 may receive encoded data of the reconstruction information, and the decoding unit 352 may decode the encoded data to generate (reconstitute) the reconstruction information.

The decoding unit 352 supplies the generated reconstructed image and reconstruction information to the error concealing unit 353.

The error concealing unit 353 acquires the reconstructed image and the reconstruction information that are supplied from the decoding unit 352, and detects a transmission error. If a transmission error is detected (that is, data is lost), the error concealing unit 353 performs error concealing and conceals the transmission error. At this point, the error concealing unit 353 conceals the transmission error according to the present technique described in <2-2. Reception of reconstruction information and error concealing>.

Specifically, the error concealing unit 353 conceals the transmission error of the reconstructed image on the basis of the reconstruction information received by the receiving unit 351.

As described in <Error concealing method> of <2-2. Reception of reconstruction information and error concealing>, any concealing method may be used. For example, the error concealing unit 353 may be configured to perform error concealing (conceal a transmission error of the reconstructed image to be processed) by using the reconstructed image having the same parameter value (characteristic value) as the reconstructed image to be processed, in the frame preceding the frame to be processed.

For example, the error concealing unit 353 may perform error concealing by using the reconstructed image having the same transmission wave characteristic as the reconstructed image to be processed, in the frame preceding the frame to be processed. The error concealing unit 353 may perform error concealing by using the reconstructed image having the same polarizing angle characteristic as the reconstructed image to be processed, in the frame preceding the frame to be processed. The error concealing unit 353 may perform error concealing by using the reconstructed image having the same transmission wavelength characteristic and polarizing angle characteristic as the reconstructed image to be processed, in the frame preceding the frame to be processed. The error concealing unit 353 may perform error concealing by using the reconstructed image having the same transmission wave characteristic and pixel position for the detection of incident light as the reconstructed image to be processed, in the frame preceding the frame to be processed. The error concealing unit 353 may perform error concealing by using the reconstructed image having the same scene identification information for the scene identification of a RAW image as the reconstructed image to be processed, in the frame preceding the frame to be processed. The error concealing unit 353 may perform error concealing on the basis of the last reconstruction information (that is, the latest reconstruction information) received by the receiving unit 351.

The error concealing unit 353 supplies, to the reconstructing unit 354, the reconstructed image supplied from the decoding unit 352 and the reconstructed image generated by error concealing.

The reconstructing unit 354 reconstructs, by using a predetermined parameter, the reconstructed image supplied from the error concealing unit 353 and generates another reconstructed image as necessary. Any parameter may be used for reconstruction. For example, the reconstructing unit 354 may perform the reconstruction by using a parameter indicated in the reconstruction information. The reconstructing unit 354 supplies the reconstructed image supplied from the error concealing unit 353 or the generated reconstructed image to the developing unit 355.

The developing unit 355 develops the reconstructed image supplied from the reconstructing unit 354 and generates a decoded image (a captured image generated by the sensor 321) including a luminance component and a color difference component. The image processing unit 356 performs image processing on the decoded image as appropriate. Any image processing may be performed. The image processing unit 356 supplies the decoded image having been subjected to image processing as appropriate, to the display unit 357.

The display unit 357 includes, for example, image display devices such as a liquid crystal display or an OELD (Organic Electro Luminescence Display) and displays the decoded image supplied from the image processing unit 356.

The provision of such a configuration allows the monitor device 302 to suppress a loss of the subjective image quality of a decoded image.

### <Multi-Camera System>

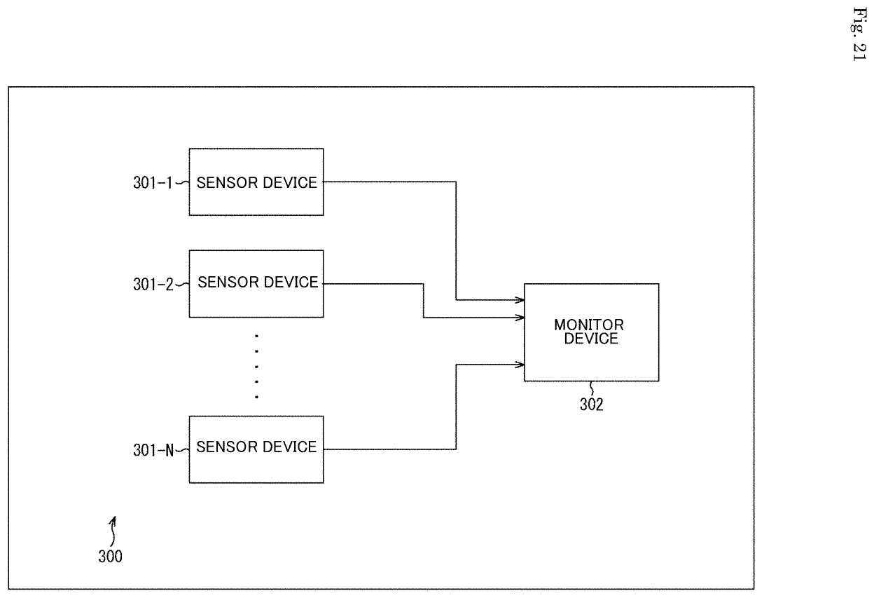

In FIG. 20, the single sensor device 301 and the single monitor device 302 are illustrated. The sensor data transmit/receive system 300 may include two or more sensor devices 301 and two or more monitor devices 302. For example, as illustrated in FIG. 21, the sensor data transmit/receive system 300 may include N sensor devices 301 (sensor devices 301-1 to 301-N).

In this case, the monitor device 302 may be provided with a switcher that selects an image to be displayed from RAW images (or reconstructed images) supplied from the sensor devices 301.

### <Flow of Transmission>

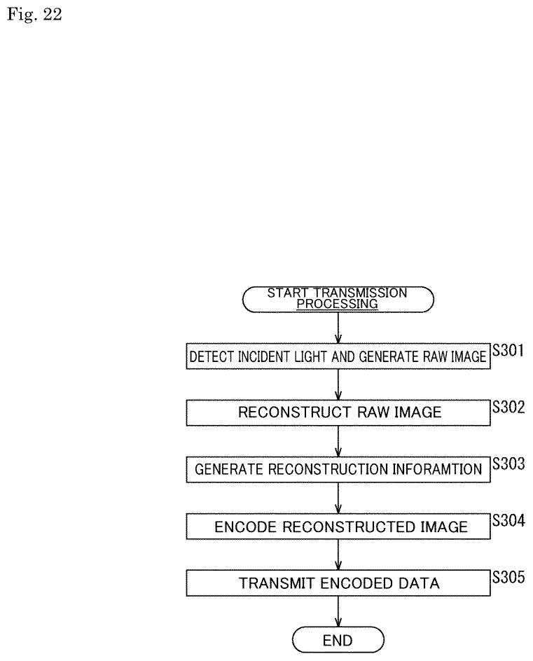

Referring to the flowchart of FIG. 22, an example of the flow of transmission performed by the sensor device 301 will be described below.

At the start of transmission, in step S301, the sensor 321 detects incident light and generates a RAW image.

In step S302, the reconstructing unit 322 reconstructs the RAW image generated in step S301.

As described in <Reconstruction method> of <2-1. Generation and transmission of reconstruction information>, for example, any parameter may be used for reconstruction. Moreover, the reconstructing unit 322 may reconstruct a RAW image in each frame according to a predetermined method shared among all of the frames and generate a reconstructed image. Furthermore, the reconstructing unit 322 may reconstruct a RAW image in each frame according to any method and generate a reconstructed image.

In step S303, the reconstruction information generating unit 323 generates reconstruction information for the reconstruction performed in step S302. At this point, the reconstruction information generating unit 323 generates the reconstruction information according to the present technique described in <2-1. Generation and transmission of reconstruction information>.

In other words, the reconstruction information generating unit 323 generates reconstruction information that corresponds to a reconstructed image obtained by reconstructing a RAW image by using a predetermined parameter and identifies the value of the parameter, the RAW image being outputted from the sensor for detecting incident light in each pixel of the pixel array.

In step S304, the encoding unit 324 encodes the reconstructed image generated in step S302 and generates the encoded data. Moreover, the encoding unit 324 stores the reconstruction information, which is generated in step S303, in the encoded data of the reconstructed image.

In step S305, the transmitting unit 325 transmits the encoded data generated in step S304 to the monitor device 302. At this point, the transmitting unit 325 transmits the reconstruction information according to the present technique described in <2-1. Generation and transmission of reconstruction information>. In other words, the transmitting unit 325 transmits the reconstruction information generated in step S303.

At the completion of the processing of step S304, the transmission is terminated.

The transmission performed thus allows the sensor device 301 to suppress a loss of the subjective image quality of a decoded image.

### <Flow of Reception>

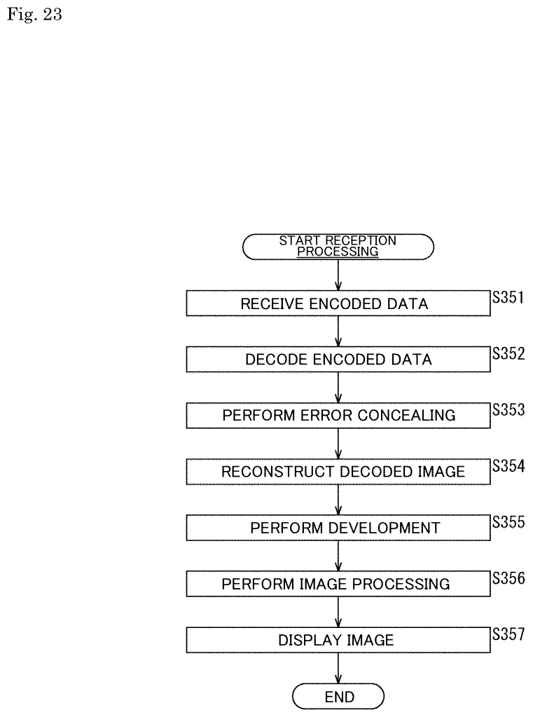

Referring to the flowchart of FIG. 23, an example of the flow of reception performed by the monitor device 302 will be described below.

At the start of reception, in step S351, the receiving unit 351 receives the encoded data that is transmitted from the sensor device 301. At this point, the receiving unit 351 receives at least the reconstruction information according to the present technique described in <2-2. Reception of reconstruction information and error concealing>.

In other words, the receiving unit 351 receives the reconstruction information that corresponds to a reconstructed image obtained by reconstructing a RAW image by using a predetermined parameter and identifies the value of the parameter, the RAW image being outputted from the sensor for detecting incident light in each pixel of the pixel array.

In step S352, the decoding unit 352 decodes the encoded data received in step S351 and generates (reconstitutes) a reconstructed image. Moreover, the decoding unit 352 extracts the reconstruction information stored in the encoded data.

In step S353, the error concealing unit 353 detects a transmission error of the reconstructed image generated (reconstituted) in step S351. If a transmission error is detected, error concealing is performed to conceal the transmission error. At this point, the error concealing unit 353 conceals the transmission error according to the present technique described in <2-2. Reception of reconstruction information and error concealing>.

Specifically, the error concealing unit 353 conceals the transmission error of the reconstructed image, which is generated (reconstituted) in step S352, on the basis of the reconstruction information received in step S351.

In step S354, the reconstructing unit 354 reconstructs the reconstructed image that is generated (reconstituted) in step S352 or the reconstructed image that is generated in step S353, as appropriate by using any parameter.

In step S355, the developing unit 355 develops the reconstructed image that is generated (reconstituted) in step S352 or the reconstructed image that is generated in step S354, and generates a decoded image (captured image).

In step S356, the image processing unit 356 performs image processing as appropriate on the decoded image (captured image) generated in step S355.

In step S357, the display unit 357 displays the decoded image having been subjected to image processing as appropriate in step S356.

At the completion of the processing of step S357, the reception is terminated.

The reception performed thus allows the monitor device 302 to suppress a loss of the subjective image quality of a decoded image.

### 4. Supplement

### <Computer>

The above-described series of processing can be executed by hardware or software. When the series of processing is executed by software, a program that constitutes the software is installed in the computer. In this case, the computer includes, for example, a computer built in dedicated hardware and a general-purpose personal computer on which various programs are installed to enable various functions.

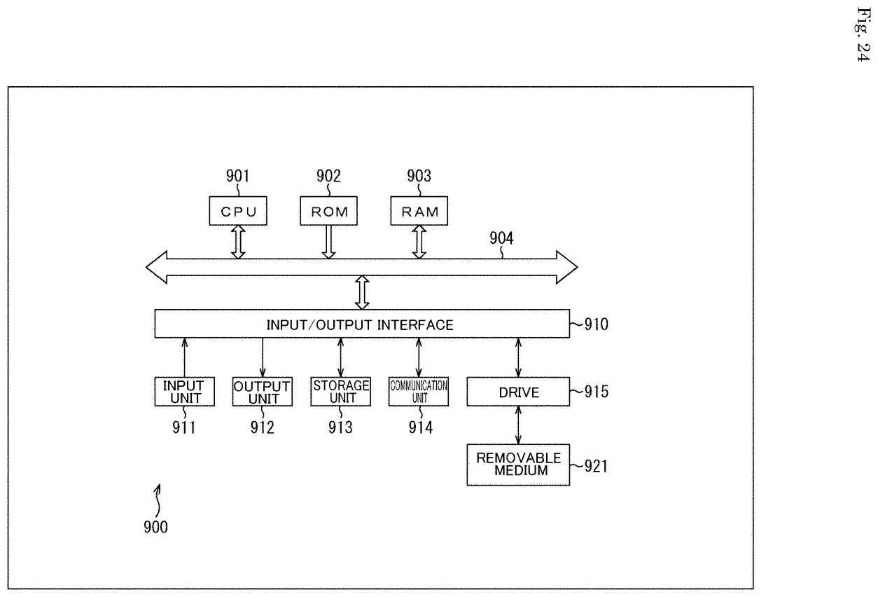

FIG. 24 is a block diagram illustrating an example of the hardware configuration of a computer that executes the series of processing by a program.

In a computer 900 illustrated in FIG. 24, a central processing unit (CPU) 901, a read only memory (ROM) 902, and a random access memory (RAM) 903 are connected to one another via a bus 904.

An input/output interface 910 is also connected to the bus 904. An input unit 911, an output unit 912, a storage unit 913, a communication unit 914, and a drive 915 are connected to the input/output interface 910.

The input unit 911 is, for example, a keyboard, a mouse, a microphone, a touch panel, or an input terminal. The output unit 912 is, for example, a display, a speaker, or an output terminal. The storage unit 913 includes, for example, a hard disk, a RAM disk, or a non-volatile memory. The communication unit 914 includes, for example, a network interface. The drive 915 drives a removable medium 921 such as a magnetic disk, an optical disc, a magneto-optical disk, or a semiconductor memory.

In the computer configured thus, the CPU 901 loads a program stored in the storage unit 913 into the RAM 903 via the input/output interface 910 and the bus 904 and executes the program, so that the series of processing is performed. Furthermore, data or the like necessary for various kinds of processing by the CPU 901 is properly stored in the RAM 903.

The program executed by the computer can be recorded and applied in, for example, the removable medium 921 as a package medium or the like. In such a case, the program can be installed in the storage unit 913 via the input/output interface 910 by loading the removable medium 921 into the drive 915.

This program can also be provided via wired or wireless transfer media such as a local area network, the Internet, and digital satellite broadcasting. In such a case, the program can be received by the communication unit 914 and installed in the storage unit 913.

Alternatively, this program can be installed in the ROM 902 or the storage unit 913 in advance.

### <Application Target of Present Technique>

The present technique can be applied to any configuration.

For example, the present technique can be applied to various electronic apparatuses such as transmitters and receivers (e.g., television receivers and cellular phones) in satellite broadcasting, wired broadcasting such as cable TV, transmission on the Internet, transmission to terminals according to cellular communication and the like, or devices (e.g., hard disk recorders and cameras) that record images in media such as an optical disc, a magnetic disk, and a flash memory or reproduce images from these storage media.

Furthermore, for example, the present technique can be implemented as a part of the configuration of the device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) in which other functions are added to the unit.

For example, the present technique can also be applied to a network system configured with a plurality of devices. The present technique may be implemented as, for example, cloud computing for processing shared among a plurality of devices via a network. For example, the present technique may be implemented in a cloud service that provides services regarding images (moving images) to any terminals such as a computer, an audio visual (AV) device, a mobile information processing terminal, and an Internet of Things (IoT) device or the like.

In the present specification, a system means a set of a plurality of constituent elements (devices, modules (parts), or the like) regardless whether all the constituent elements are contained in the same casing. Accordingly, a plurality of devices accommodated in separate casings and connected via a network and a single device accommodating a plurality of modules in a single casing are all referred to as a system.

<Fields and Applications to which Present Technique is Applicable>

A system, device, a processing unit, and the like to which the present technique is applied can be used in any fields such as traffic, medical treatment, security, agriculture, livestock industries, a mining industry, beauty, factories, home appliance, weather, and natural surveillance, for example. The present technique may be used for any purpose.

For example, the present technique can be applied to systems and devices for providing ornamental contents and the like. In addition, for example, the present technique can be applied to systems and devices available for traffic, such as traffic condition monitoring and autonomous driving control. Furthermore, for example, the present technique can be applied to systems and devices available for security. In addition, for example, the present technique can be applied to systems and devices available for automatic control of machines and the like. Furthermore, for example, the present technique can be applied to systems and devices available for agriculture and livestock industry. In addition, the present technique can also be applied, for example, to systems and devices for monitoring natural conditions such as volcanoes, forests, and oceans and wildlife. Furthermore, for example, the present technique can be applied to systems and devices available for sports.

### <Others>

The embodiments of the present technique are not limited to the above-described embodiments, and various modifications can be made without departing from the spirit of the present technique.

For example, a configuration described as one device (or processing unit) may be split into and configured as a plurality of devices (or processing units). Conversely, configurations described above as a plurality of devices (or processing units) may be integrated and configured as one device (or processing unit). It is a matter of course that configurations other than the aforementioned configurations may be added to the configuration of each device (or each processing unit). Moreover, some of configurations of a certain device (or processing unit) may be included in a configuration of another device (or another processing unit) as long as the configurations and operations of the overall system are substantially identical to one another.

For example, the aforementioned program may be executed by any device. In this case, the device only needs to have necessary functions (such as functional blocks) to obtain necessary information.

Moreover, for example, each step of one flowchart may be executed by one device, or may be shared and executed by a plurality of devices. Furthermore, when a plurality of processes are included in one step, one device may execute the plurality of processes, or the plurality of devices may share and execute the plurality of processes. In other words, it is also possible to execute the plurality of processes included in one step as processing of a plurality of steps. In contrast, processing described as a plurality of steps can be collectively performed as one step.

Moreover, the program to be executed by a computer may have the following features. For example, the processing of steps described in the program may be executed in chronological order according to the order described in this specification. Furthermore, the processing of some steps described in the program may be executed in parallel. Additionally, the processing of steps described in the program may be individually executed with necessary timing, for example, when being called. In short, the processing of the respective steps may be executed in an order different from the above-described order unless any contradiction arises. Moreover, the processing of some steps described in this program may be executed in parallel with the processing of another program. Furthermore, the processing of steps described in this program may be executed in combination with the processing of another program.

Moreover, for example, a plurality of modes related to the present technique can be independently implemented unless any contradiction arises. As a matter of course, any number of modes of the present technique can be implemented in combination. For example, some or all of the modes of the present technique described in any one of the embodiments can be implemented in combination with some or all of the mode described in other embodiments. Furthermore, any or all of the modes of the present technique can be implemented in combination with other unmentioned modes.

The present technique can also be configured as follows:

(1) An information processing device including: a reconstruction information generating unit that generates reconstruction information that corresponds to a reconstructed image obtained by reconstructing a RAW image by using a predetermined parameter and identifies the value of the parameter, the RAW image being outputted from a sensor for detecting incident light in each pixel of a pixel array; and
a transmitting unit that transmits the reconstruction information.

(2) The information processing device according to (1), wherein the reconstruction information includes information about a correlation between the reconstructed image and identification information about the value of the parameter.

(3) The information processing device according to (2), wherein the reconstruction information further includes information about a correlation between the value of the parameter and the identification information.

(4) The information processing device according to (1), wherein the reconstruction information includes information about a correlation between the reconstructed image and the value of the parameter.

(5) The information processing device according to any one of (1) to (4), wherein the parameter includes an optical property parameter for an optical property of the incident light detected by the sensor.

(6) The information processing device according to (5), wherein the optical property parameter includes a parameter for a transmission wavelength characteristic that is a wavelength characteristic of the incident light.

(7) The information processing device according to (5), wherein the optical property parameter includes a parameter for a polarizing angle characteristic of the incident light.

(8) The information processing device according to (5), wherein the optical property parameter includes a parameter for a transmission wavelength characteristic that is a wavelength characteristic of the incident light and a parameter for a polarizing angle characteristic of the incident light.

(9) The information processing device according to any one of (5) to (8), wherein the optical property parameter includes a parameter for a transmission wavelength characteristic that is a wavelength characteristic of the incident light, and
the parameter further includes a parameter for a position of a pixel for detecting the incident light.

(10) The information processing device according to any one of (1) to (9), wherein the parameter includes a non-optical property parameter for a property other than an optical property of the incident light detected by the sensor.

(11) The information processing device according to (10), wherein the non-optical parameter includes scene identification information for identifying a scene of the RAW image.

(12) The information processing device according to any one of (1) to (11), wherein the transmitting unit transmits SEI (Supplemental Enhancement Information) of encoded data of the reconstructed image while the reconstruction information is stored in the SEI.

(13) The information processing device according to any one of (1) to (12), wherein the reconstruction information generating unit generates the reconstruction information in a first frame as information to be applied to all frames.

(14) The information processing device according to any one of (1) to (12), wherein the reconstruction information generating unit generates the reconstruction information in each frame.

(15) The information processing device according to any one of (1) to (12), wherein the reconstruction information generating unit generates the reconstruction information in a frame where a method of reconstruction is changed, as information to be applied to frames from the current frame to the frame preceding the frame where the method of reconstruction is to be subsequently changed.

(16) The information processing device according to any one of (1) to (15), further including a reconstructing unit that reconstructs the RAW image in each frame according to a predetermined method shared among all of the frames and generates the reconstructed image.

(17) The information processing device according to any one of (1) to (15), further including a reconstructing unit that reconstructs the RAW image in each frame according to any method and generates the reconstructed image.

(18) The information processing device according to any one of (1) to (17), further including an encoding unit that encodes the reconstruction information and generates encoded data, wherein the transmitting unit is configured to transmit the encoded data of the reconstruction information.

(19) An information processing method including: generating reconstruction information that corresponds to a reconstructed image obtained by reconstructing a RAW image by using a predetermined parameter and identifies the value of the parameter, the RAW image being outputted from a sensor for detecting incident light in each pixel of a pixel array; and
transmitting the generated reconstruction information.

(31) An information processing device including: a receiving unit configured to receive reconstruction information that corresponds to a reconstructed image obtained by reconstructing a RAW image by using a predetermined parameter and identifies the value of the parameter, the RAW image being outputted from a sensor for detecting incident light in each pixel of a pixel array; and a concealing unit that conceals a transmission error of the reconstructed image on the basis of the reconstruction information.

(32) The information processing device according to (31), wherein the reconstruction information includes information about a correlation between the reconstructed image and identification information about the value of the parameter.

(33) The information processing device according to (32), wherein the reconstruction information further includes information about a correlation between the value of the parameter and the identification information.

(34) The information processing device according to (31), wherein the reconstruction information includes information about a correlation between the reconstructed image and the value of the parameter.

(35) The information processing device according to any one of (31) to (34), wherein the parameter includes an optical property parameter for an optical property of the incident light detected by the sensor.

(36) The information processing device according to (35), wherein the optical property parameter includes a parameter for a transmission wavelength characteristic that is a wavelength characteristic of the incident light.

(37) The information processing device according to (35), wherein the optical property parameter includes a parameter for a polarizing angle characteristic of the incident light.

(38) The information processing device according to (35), wherein the optical property parameter includes a parameter for a transmission wavelength characteristic that is a wavelength characteristic of the incident light and a parameter for a polarizing angle characteristic of the incident light.

(39) The information processing device according to any one of (35) to (38), wherein the optical property parameter includes a parameter for a transmission wavelength characteristic that is a wavelength characteristic of the incident light, and
the parameter further includes a parameter for a position of a pixel for detecting the incident light.

(40) The information processing device according to any one of (31) to (39), wherein the parameter includes a non-optical property parameter for a property other than an optical property of the incident light detected by the sensor.

(41) The information processing device according to (40), wherein the non-optical parameter includes scene identification information for identifying a scene of the RAW image.

(42) The information processing device according to any one of (31) to (41), wherein the receiving unit receives SEI (Supplemental Enhancement Information) of encoded data of the reconstructed image while the reconstruction information is stored in the SEI.

(43) The information processing device according to any one of (31) to (42), wherein the receiving unit receives the reconstruction information in a first frame as information to be applied to all frames.

(44) The information processing device according to any one of (31) to (42), wherein the receiving unit receives the reconstruction information in each frame.

(45) The information processing device according to any one of (31) to (42), wherein the receiving unit receives the reconstruction information in a frame where a method of reconstruction is changed, the reconstruction information being applied to frames from the current frame to the frame preceding the frame where the method of reconstruction is to be subsequently changed.

(46) The information processing device according to any one of (31) to (45), wherein the concealing unit conceals the transmission error of the reconstructed image to be processed, by using the reconstructed image having the same parameter value as the reconstructed image to be processed, in the frame preceding the frame to be processed.

(47) The information processing device according to (46), wherein the concealing unit conceals the transmission error of the reconstructed image to be processed, by using the reconstructed image having the same transmission wave characteristic as the reconstructed image to be processed, in the frame preceding the frame to be processed, the transmission wave characteristic serving as a wavelength characteristic of the incident light.

(48) The information processing device according to (46), wherein the concealing unit conceals the transmission error of the reconstructed image to be processed, by using the reconstructed image having the same polarizing angle characteristic of the incident light as the reconstructed image to be processed, in the frame preceding the frame to be processed.

(49) The information processing device according to (46), wherein the concealing unit conceals the transmission error of the reconstructed image to be processed, by using the reconstructed image having the same transmission wave characteristic and the same polarizing angle characteristic of the incident light as the reconstructed image to be processed, in the frame preceding the frame to be processed, the transmission wave characteristic serving as a wavelength characteristic of the incident light.

(50) The information processing device according to any one of (46) to (49), wherein the concealing unit conceals the transmission error of the reconstructed image to be processed, by using the reconstructed image having the same transmission wave characteristic and the same pixel position for detection of the incident light as the reconstructed image to be processed, in the frame preceding the frame to be processed, the transmission wave characteristic serving as a wavelength characteristic of the incident light.

(51) The information processing device according to any one of (46) to (50), wherein the concealing unit conceals the transmission error of the reconstructed image to be processed, by using the reconstructed image having the same scene identification information for identification of a scene of the RAW image as the reconstructed image to be processed, in the frame preceding the frame to be processed.

(52) The information processing device according to any one of (31) to (51), wherein the concealing unit conceals the transmission error of the reconstructed image on the basis of the last reconstruction information received by the receiving unit.

(53) The information processing device according to any one of (31) to (52), wherein the receiving unit is configured to receive encoded data of the reconstruction information, the information processing device further comprising a decoding unit that decodes the encoded data and generates the reconstruction information.

(54) An information processing method including: receiving reconstruction information that corresponds to a reconstructed image obtained by reconstructing a RAW image by using a predetermined parameter and identifies the value of the parameter, the RAW image being outputted from a sensor for detecting incident light in each pixel of a pixel array; and
concealing a transmission error of the reconstructed image on the basis of the received reconstruction information.

### REFERENCE SIGNS LIST

300 Sensor data transmit/receive system
301 Sensor device
302 Monitor device
321 Sensor
322 Reconstructing unit
323 Reconstruction information generating unit
324 Encoding unit
325 Transmitting unit
351 Receiving unit
352 Decoding unit
353 Error concealing unit
354 Reconstructing unit
355 Developing unit
356 Imaging processing unit
357 Display unit
900 Computer

1. An information processing device comprising: a reconstruction information generating unit that generates reconstruction information that corresponds to a reconstructed image obtained by reconstructing a RAW image by using a predetermined parameter and identifies a value of the parameter, the RAW image being outputted from a sensor for detecting incident light in each pixel of a pixel array; and
a transmitting unit that transmits the reconstruction information.

2. The information processing device according to claim 1, wherein the reconstruction information includes information about a correlation between the reconstructed image and identification information about the value of the parameter.

3. The information processing device according to claim 1, wherein the reconstruction information includes information about a correlation between the reconstructed image and the value of the parameter.

4. The information processing device according to claim 1, wherein the parameter includes an optical property parameter for an optical property of the incident light detected by the sensor.

5. The information processing device according to claim 4, wherein the optical property parameter includes a parameter for a transmission wavelength characteristic that is a wavelength characteristic of the incident light.

6. The information processing device according to claim 4, wherein the optical property parameter includes a parameter for a polarizing angle characteristic of the incident light.

7. The information processing device according to claim 1, wherein the parameter includes a non-optical property parameter for a property other than an optical property of the incident light detected by the sensor.

8. The information processing device according to claim 1, wherein the transmitting unit transmits SEI (Supplemental Enhancement Information) of encoded data of the reconstructed image while the reconstruction information is stored in the SEI.

9. The information processing device according to claim 1, wherein the reconstruction information generating unit generates the reconstruction information in a first frame as information to be applied to all frames.

10. The information processing device according to claim 1, wherein the reconstruction information generating unit generates the reconstruction information in each frame.

11. The information processing device according to claim 1, wherein the reconstruction information generating unit generates the reconstruction information in a frame where a method of reconstruction is changed, as information to be applied to frames from the current frame to the frame preceding the frame where the method of reconstruction is to be subsequently changed.

12. The information processing device according to claim 1, further comprising a reconstructing unit that reconstructs the RAW image in each frame according to a predetermined method shared among all of the frames and generates the reconstructed image.

13. The information processing device according to claim 1, further comprising a reconstructing unit that reconstructs the RAW image in each frame according to any method and generates the reconstructed image.

14. The information processing device according to claim 1, further comprising an encoding unit that encodes the reconstruction information and generates encoded data, wherein the transmitting unit is configured to transmit the encoded data of the reconstruction information.

15. An information processing method comprising: generating reconstruction information that corresponds to a reconstructed image obtained by reconstructing a RAW image by using a predetermined parameter and identifies a value of the parameter, the RAW image being outputted from a sensor for detecting incident light in each pixel of a pixel array; and
transmitting the generated reconstruction information.

16. An information processing device comprising: a receiving unit configured to receive reconstruction information that corresponds to a reconstructed image obtained by reconstructing a RAW image by using a predetermined parameter and identifies a value of the parameter, the RAW image being outputted from a sensor for detecting incident light in each pixel of a pixel array; and
a concealing unit that conceals a transmission error of the reconstructed image on a basis of the reconstruction information.

17. The information processing device according to claim 16, wherein the concealing unit conceals the transmission error of the reconstructed image to be processed, by using the reconstructed image having the same parameter value as the reconstructed image to be processed, in the frame preceding the frame to be processed.

18. The information processing device according to claim 16, wherein the concealing unit conceals the transmission error of the reconstructed image on a basis of the last reconstruction information received by the receiving unit.

19. The information processing device according to claim 16, wherein the receiving unit receives encoded data of the reconstruction information, the information processing device further comprising a decoding unit configured to decode the encoded data and generate the reconstruction information.

20. An information processing method comprising: receiving reconstruction information that corresponds to a reconstructed image obtained by reconstructing a RAW image by using a predetermined parameter and identifies a value of the parameter, the RAW image being outputted from a sensor for detecting incident light in each pixel of a pixel array; and
concealing a transmission error of the reconstructed image on a basis of the received reconstruction information.
